(19) United States
(12) Patent Application Publication
(10) Pub. No.: US 2021/0146310 A1
(43) Pub. Date: May 20, 2021

(54) PVP- AND/OR PVL-CONTAINING COMPOSITE MEMBRANES AND METHODS OF USE

(71) Applicant: 3M INNOVATIVE PROPERTIES COMPANY, St Paul, MN (US)

(72) Inventors: Jinsheng Zhou, Woodbury, MN (US); Kazuhiko Mizuno, Tokyo (JP); Moses M. David, Wells, TX (US)

(21) Appl. No.: 16/638,166

(22) PCT Filed: Aug. 14, 2018
(86) PCT No.: PCT/US2018/046626

§ 371 Date: Feb. 11, 2020

Related U.S. Application Data
(60) Provisional application No. 62/546,148, filed on Aug. 16, 2017.

(51) Int. Cl. B01D 61/36; B01D 67/00; B01D 69/10; B01D 69/12; B01D 71/44; B01D 71/78

(52) U.S. Cl. CPC B01D 61/362; B01D 67/009; B01D 69/10; B01D 69/127; B01D 2323/40; B01D 71/78; B01D 2323/30; B01D 2323/345; B01D 71/44

(57) ABSTRACT

A composite membrane for selectively pervaporating a first liquid from a mixture comprising the first liquid and a second liquid. The composite membrane includes a porous substrate comprising opposite first and second major surfaces, and a plurality of pores. A PVP- or PVL-containing polymer is disposed in at least some of the pores so as to form a layer having a thickness within the porous substrate and/or disposed on top of the pores to form a layer.

### BACKGROUND

Separation membranes are known; however, there is a continual need for effective composite membranes.

### SUMMARY OF THE INVENTION

The present disclosure provides composite membranes and methods of use of such membranes in separation techniques. Generally, the composite membranes include a porous substrate (i.e., a support substrate that may include one or more layers) that includes opposite first and second major surfaces, and a plurality of pores; and a polymer composition disposed in and/or on the porous substrate (disposed in at least some of the plurality of pores so as to form a layer having a thickness). In certain embodiments the layer is a continuous layer. For composite membranes that are asymmetric, the amount of the polymer at, or adjacent to, the first major surface is greater than the amount of the polymer at, or adjacent to, the second major surface.

The polymer composition is:

(a) a PVP-containing polymer composition that is not a pore-filling polymer composition;

(b) a PVP-containing polymer composition comprising greater than 75 weight percent (wt-%) PVP, wherein the PVP-containing polymer composition is disposed in and/or on the porous substrate;

(c) a PVP-containing polymer composition comprising one or more additional polymers that does not include a polymer derived from one or more ethylenically unsaturated monomers and/or oligomers, wherein the PVP-containing polymer composition is disposed in and/or on the porous substrate; or
(d) a PVL-containing polymer composition disposed in and/or on the porous substrate.

The polymer composition in the polymer layer of the composite membranes of the disclosure includes at least one polymer crosslinked with actinic radiation (e.g., UV, e-beam, or gamma radiation) and/or at least one polymer grafted to the porous substrate. In certain embodiments, the polymer composition in the polymer layer includes an interpenetrating network of two or more polymers.

Such membranes are particularly useful for selectively pervaporating a first liquid from a mixture that includes the first liquid and a second liquid, generally because the polymer composition is more permeable to the first liquid (e.g., alcohols, particularly higher octane alcohols, sulfur-containing compounds, aromatics, and other high octane compounds) than the second liquid (e.g., gasoline and other such fuels). Furthermore, the polymer composition is not soluble in at least a mixture of the first liquid and the second liquid, and preferably, in the first liquid and the second liquid.

The second liquid (e.g., gasoline) could naturally include the first liquid (e.g., high octane compounds or sulfur-containing compounds), or the first liquid (e.g., alcohols or high octane compounds) could be added to the second liquid (e.g., gasoline).

Such membranes may be included in a cartridge, which may be part of a system such as a flex-fuel engine.

The present disclosure also provides methods. For example, the present disclosure provides a method of separating a first liquid (e.g., ethanol, other higher octane alcohols, sulfur-containing compounds, aromatics, and other high octane compounds) from a mixture of the first liquid (e.g., ethanol, other higher octane alcohols, sulfur-containing compounds, aromatics, and other high octane compounds) and a second liquid (e.g., gasoline and other such fuels), the method comprising contacting the mixture with a composite membrane (preferably, an asymmetric composite membrane) as described herein.

Herein, “gasoline” refers to refined petroleum used as fuel for internal combustion engines.

Herein, a “high octane” compound is one that has an octane level (i.e., octane rating or octane number), which is a standard measure of the performance of gasoline, of at least 87 on the AKI (anti-knock index), which is the average of the RON (research octane number) and MON (motor octane number) indices.

The terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to claims of the disclosure that may afford certain benefits, under certain circumstances. However, other claims may also be preferred, under the same or other circumstances. Furthermore, the recitation of one or more preferred claims does not imply that other claims are not useful, and is not intended to exclude other claims from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numerical values are assumed to be modified by the term “about” and in certain situations, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C. or 22° C. to 25° C.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIGS. 1A, 1B, and 1C are cross-sectional schematic views of exemplary porous substrates and an asymmetric composite membranes of the present disclosure. The porous structure of the porous substrate is not to scale and not representative of the actual structure.

FIG. 2 is a perspective side view of a module that includes an exemplary composite membrane of the present disclosure.

FIG. 3 is an illustration of an exemplary fuel separation system that includes an exemplary composite membrane of the present disclosure.

FIG. 4 is an illustration of a vacuum pervaporation testing apparatus.

FIG. 5 is an illustration of an alternative vacuum pervaporation testing apparatus.

FIG. 6 is an SEM cross-section image (30,000× magnification) of PAN350 (polyacrylonitrile) substrate (from Nanostone Water, formerly known as Sepro Membranes Inc. of Oceanside, Calif.) used in Examples 1-60. Layer 1 is a nanoporous layer, layer 2 is a microporous layer (a macroporous layer is not shown). Sample was freeze fractured in liquid nitrogen and imaged using Hitachi S4500 FESEM scanning electron microscope (SEM).

### DETAILED DESCRIPTION OF ILLUSTRATIVE EMBODIMENTS

The present disclosure provides composite membranes (preferably, asymmetric composite membranes) that include a porous substrate and a polymer composition that may be disposed in and/or on the porous substrate. The porous substrate has opposite first and second major surfaces, and a plurality of pores.

In certain embodiments, the polymer composition is a pore-filling polymer composition that is disposed in at least some of the pores. In certain embodiments, the polymer composition is not a pore-filling polymer composition.

In certain embodiments in which the composite membranes are asymmetric composite membranes the amount of the polymer composition at, or adjacent to, the first major surface is greater than the amount of the polymer composition at, or adjacent to, the second major surface. Hence, a composite membrane is asymmetric with respect to the amount of polymer composition throughout the thickness of the porous substrate.

The polymer composition used to form a composite membrane of the present disclosure is at least one of:

(a) a PVP-containing polymer composition that is not a pore-filling polymer composition;

(b) a PVP-containing polymer composition comprising greater than 75 wt-% PVP, wherein the PVP-containing polymer composition is disposed in and/or on the porous substrate;

(c) a PVP-containing polymer composition comprising one or more additional polymers that does not include a polymer derived from one or more ethylenically unsaturated monomers and/or oligomers, wherein the PVP-containing polymer composition is disposed in and/or on the porous substrate; or

(d) a PVL-containing polymer composition disposed in and/or on the porous substrate.

The polymer composition in the polymer layer of the composite membranes of the disclosure includes at least one polymer crosslinked with actinic radiation (e.g., UV, e-beam, or gamma radiation) and/or at least one polymer grafted to the porous substrate. In certain embodiments, the polymer composition in the polymer layer includes an interpenetrating network of two or more polymers.

Such composite membranes may be used in various separation methods, including pervaporation, gas separation, vapor permeation, nanofiltration, organic solvent nanofiltration, and combinations thereof (e.g., a combination of pervaporation and vapor permeation).

Such separation methods may be used to separate a first fluid (i.e., liquid and/or vapor) from a feed mixture of a first fluid (i.e., liquid and/or vapor) and a second fluid (i.e., liquid and/or vapor). The first fluid may be a natural or inherent component of the second fluid, or the first fluid could be an additive in the second fluid. Either type of mixture may be a “feed mixture” as used herein.

The preferred separation membranes of the present disclosure are particularly useful in pervaporation methods to separate a first fluid (e.g., first liquid) from a feed mixture of a first fluid (e.g., first liquid) and a second fluid (e.g., second liquid).

In certain embodiments, the composite membranes (preferably, asymmetric composite membranes) include a porous substrate and a polymer composition. The porous substrate has opposite first and second major surfaces, and a plurality of pores. The polymer composition may be disposed only on the surface of the porous substrate, disposed only in at least a portion of the plurality of pores (forming a pore-filling polymer layer), or the polymer composition may be disposed on the surface and in at least a portion of the pores (forming a pore-filling polymer layer).

In certain embodiments in which the composite membranes are asymmetric composite membranes, the amount of the polymer composition at, or adjacent to, the first major surface is greater than the amount of the polymer composition at, or adjacent to, the second major surface. Hence, a composite membrane is asymmetric with respect to the amount of polymer composition (pore-filling polymer) throughout the thickness of the porous substrate.

Such separation membranes may be used in various separation methods, including pervaporation, gas separation, vapor permeation, nanofiltration, organic solvent nanofiltration, and combinations thereof (e.g., a combination of pervaporation and vapor permeation). Such separation methods may be used to separate a first fluid (i.e., liquid and/or vapor) from a feed mixture of a first fluid (i.e., liquid and/or vapor) and a second fluid (i.e., liquid and/or vapor).

The preferred separation membranes of the present disclosure are particularly useful in pervaporation methods to separate a first liquid from a feed mixture of a first liquid and a second liquid.

In certain embodiments, separation membranes of the present disclosure are composite membranes and include a porous substrate (i.e., a support substrate which may be in the form of one or more porous layers) that includes opposite first and second major surfaces, and a plurality of pores; and a polymer composition that forms a layer having a thickness in and/or on the porous substrate. In certain embodiments, the polymer composition layer is preferably a continuous layer. The amount of the polymer composition at, or adjacent to, the first major surface is greater than the amount of the polymer composition at, or adjacent to, the second major surface in an asymmetric composite membrane.

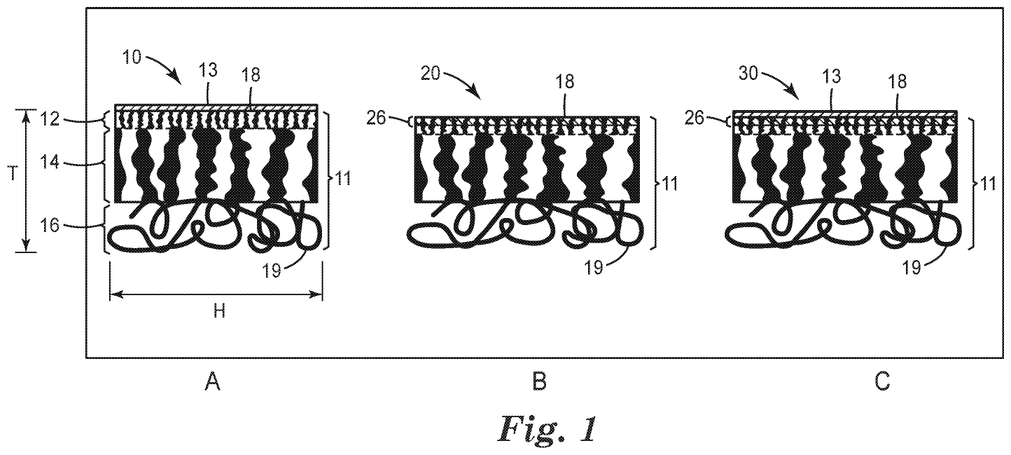

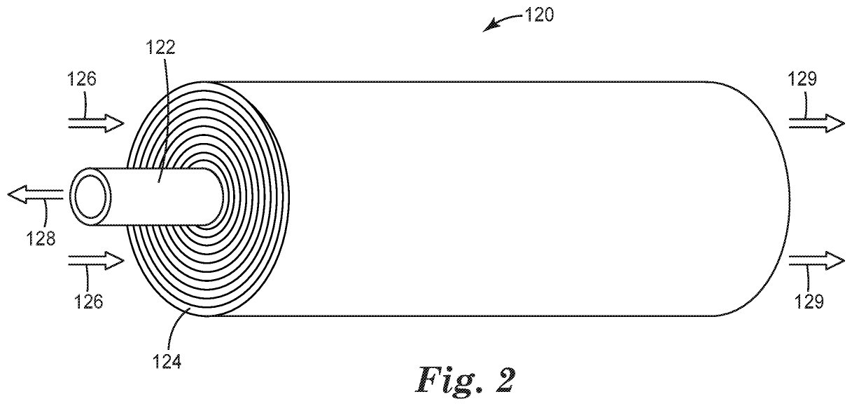

FIG. 1 provides illustrations of: a first exemplary asymmetric composite membrane 10 that includes a porous substrate 11 with polymer composition coated only in a layer 13 on first major surface 18 of the porous substrate (FIG. 1A); a second exemplary asymmetric composite membrane 20 that includes porous substrate 11 with polymer composition coated only in a portion of the pores of the porous substrate forming a pore-filling polymer layer 26 adjacent to major surface 18 (FIG. 1B); and an exemplary asymmetric composite membrane 30 with polymer composition coated both in a layer 13 on first major surface 18 and in a portion of the pores of the porous substrate forming a pore-filling polymer layer 26 adjacent to major surface 18 (FIG. 1C), all shown in vertical cross-section.

The exemplary porous substrate 11 shown in FIG. 1 includes three layers that include a nanoporous layer 12, a microporous layer 14, and a macroporous layer 16 (FIG. 1A) having a first major surface 18 and a second major surface 19. It should be understood that a porous substrate suitable for use in the composite membranes of the present disclosure does not require either a nanoporous layer 12 or a macroporous layer 16.

In a porous substrate 11, the pores are interconnected vertically (i.e., throughout the thickness “T” of the porous substrate 11, see FIG. 1A). In certain preferred embodiments, the pores of the porous substrate 11 are interconnected horizontally (e.g., as in a microfiltration membrane) along dimension “H” (see FIG. 1A). In such embodiments, the pore-filling polymer layer 26 (FIGS. 1B and 1C) formed by the pore-filling polymer composition is preferably a continuous layer. If the pores of the porous substrate 11 are not all interconnected horizontally (along dimension “H”), the layer 26 is discontinuous (i.e., the pore-filling polymer forms a plurality of discreet regions within the porous substrate). It will be understood that dimension “H” generally refers to the plane of the porous substrate and is exemplary of all the various horizontal dimensions within a horizontal slice of the substrate (shown in vertical cross-section). Whether layer 26 is continuous or discontinuous, for the asymmetric composite membrane, the amount of the pore-filling polymer composition at, or adjacent to, the first major surface 18 is greater than the amount of the polymer at, or adjacent to, the second major surface 19.

Referring to FIG. 1A, the polymer composition forms a coating 13 on (i.e., covers) the top surface 18 of the substrate 11. Referring to FIG. 1C, the polymer composition forms a coating 13 on (i.e., covers) the top surface 18 of the substrate 11 in addition to being within the pores of the substrate forming layer 26. This coating layer 13 may be continuous or discontinuous.

Thus, in certain embodiments, the polymer composition is in the form of a pore-filling polymer layer 26 (FIG. 1C) that forms at least a portion of the first major surface 18 of the porous substrate. In certain embodiments, the polymer composition is in the form of a pore-filling polymer layer having an exposed major surface, which coats the first major surface of the porous substrate, and an opposite major surface disposed between the opposite first and second major surfaces of the porous substrate. In certain embodiments, the exposed major surface of the polymer composition layer coats all the first major surface of the porous substrate.

As used herein, a continuous layer refers to a substantially continuous layer as well as a layer that is completely continuous. That is, as used herein, any reference to the polymer composition layer coating or covering the first major surface of the porous substrate includes the polymer composition layer coating all, substantially all, or only a portion of the first major surface of the porous substrate. The polymer composition layer is considered to coat substantially all of the first major surface of the porous substrate (i.e., be substantially continuous), when enough of the first major surface of the porous substrate is coated such that the composite membrane is able to selectively separate (e.g., pervaporate) a desired amount of a first fluid (e.g., first liquid such as alcohol, or other high octane compounds such as aromatics) from a mixture of the first fluid (e.g., first liquid such as alcohol or other high octane compound) with a second fluid (e.g., second liquid such as gasoline or other such fuel). In particular, the flux and the selectivity of the separation membrane (with a “continuous layer” of polymer composition) is sufficient for the particular system in which the membrane is used.

In certain embodiments, the polymer composition layer (both layer 13 and/or pore-filling layer 26) has a thickness in the range of from 10 nm up to and including 50,000 nm (50 microns), or up to and including 20,000 nm. More specifically, the thickness of the polymer composition layer may include, in increments of 1 nm, any range between 10 nm and 20,000 nm. For example, the thickness of the polymer composition layer may be in the range of from 11 nm to 5999 nm, or 20 nm to 6000 nm, or 50 nm to 5000 nm, etc.

Composite membranes of the present disclosure may further include at least one of: (a) an ionic liquid mixed with the polymer composition; or (b) an amorphous fluorochemical film disposed on the composite membrane, typically, on the side of the membrane the feed mixture enters. Such composite membranes demonstrate improved performance (e.g., flux) and/or durability over the same composite membranes without either the ionic liquid or the amorphous fluorochemical film.

### Pervaporation

Pervaporation is a process that involves a membrane in contact with a liquid on the feed or upstream side and a vapor on the “permeate” or downstream side. Usually, a vacuum and/or an inert gas is applied on the vapor side of the membrane to provide a driving force for the process. Typically, the downstream pressure is lower than the saturation pressure of the permeate.

Vapor permeation is quite similar to pervaporation, except that a vapor is contacted on the feed side of the membrane instead of a liquid. As membranes suitable for pervaporation separations are typically also suitable for vapor permeation separations, use of the term “pervaporation” may encompass both “pervaporation” and “vapor permeation.”

Pervaporation may be used for desulfurization of gasoline, dehydration of organic solvents, isolation of aroma compounds or components (i.e., odorants), and removal of volatile organic compounds from aqueous solutions. Pervaporation may be used also for separating and concentrating high octane compounds from a fuel mixture for use in “octane-on-demand” internal combustion engines. In certain embodiments of the present disclosure, the asymmetric composite membranes are used for pervaporating high octane compounds (e.g., alcohol and/or aromatics) from a mixture of gasoline and alcohol and/or aromatics. In certain embodiments of the present disclosure, the asymmetric composite membranes are used for pervaporating alcohol from an alcohol and gasoline mixture.

Separation membranes described herein are particularly useful for selectively pervaporating a first fluid (e.g., a first liquid such as high octane compounds) from a mixture that includes the first fluid (e.g., a first liquid such as high octane compounds) and a second fluid (e.g., a second liquid such as gasoline or other such fuels), generally because the polymer composition is more permeable to the first fluid (e.g., first liquid) than the second fluid (e.g., second liquid).

In certain embodiments, the first liquid is a more polar liquid than the second liquid. The second liquid may be a nonpolar liquid.

In certain embodiments, the first liquid may be water, an alcohol (such as ethanol, methanol, 1-propanol, 2-propanol, 1-methoxy-2-propanol, or butanol), or an organic sulfur-containing compound (such as thiophene, tetrahydrothiophene, benzothiophene, 2-methylthiophene, or 2,5-dimethylthiophene). In certain embodiments, the first liquid may be high octane compounds, such as an alcohol, or aromatic hydrocarbons (i.e., aromatics) such as toluene and xylene.

Some compounds may be removed because they are undesirable (e.g., sulfur-containing compounds in fuel such as gasoline). Some compounds may be removed because they are desirable to form a separate concentrate for later use (e.g., high octane compounds such as aromatics). Thus, in certain embodiments, the first liquid may be a high octane compound, i.e., one having an octane rating of at least 87 (AKI) (e.g., ethanol and aromatics).

In certain embodiments, the second liquid may be gasoline or other such fuel. In certain embodiments, the first liquid is an alcohol, and the second liquid is gasoline. Thus, in one embodiment of the present disclosure, an asymmetric composite membrane for selectively pervaporating alcohol from an alcohol and gasoline feed mixture is provided. This asymmetric composite membrane includes: a porous substrate having opposite first and second major surfaces, and a plurality of pores; and a pore-filling polymer disposed in at least some of the pores so as to form a continuous layer having a thickness, with the amount of the polymer at, or adjacent to, the first major surface being greater than the amount of the pore-filling polymer at, or adjacent to, the second major surface, wherein the polymer is more permeable to alcohol than gasoline.

In other embodiments, a composite membrane for selectively pervaporating alcohol from an alcohol and gasoline feed mixture is provided, wherein the composite membrane includes: a porous substrate having opposite first and second major surfaces and a plurality of pores; and a polymer composition that is not pore filling.

In certain embodiments, the first liquid is an organic compound having an octane rating of at least 87, and the second liquid is a fuel (e.g., gasoline). Thus, in one embodiment of the present disclosure, an asymmetric composite membrane for selectively pervaporating a high octane compound from a fuel feed mixture that includes such high octane compounds is provided. This method results in separating and concentrating high octane compounds. This asymmetric composite membrane includes: a porous substrate having opposite first and second major surfaces, and a plurality of pores; and a pore-filling polymer disposed in at least some of the pores so as to form a continuous layer having a thickness, with the amount of the polymer at, or adjacent to, the first major surface being greater than the amount of the pore-filling polymer at, or adjacent to, the second major surface, wherein the polymer is more permeable to the high octane compounds than the other components (e.g., low octane compounds) in the fuel.

In other embodiments, a composite membrane for selectively pervaporating a high octane compound from a fuel feed mixture that includes such high octane compounds is provided, wherein the composite membrane includes: a porous substrate having opposite first and second major surfaces and a plurality of pores; and a polymer composition that is not pore filling.

Low octane compounds, i.e., those having an octane rating of less than 87 (AKI) include, for example, n-hexane, n-pentane, n-octane, n-nonane, n-dexane. High octane compounds, i.e., those having an octane rating of at least 87 (AKI) include, for example, methanol, ethanol, iso-butanol, as well as xylene, toluene, and other aromatics.

### Porous Substrate

The porous substrate itself may be asymmetric or symmetric. The porous substrate may include one layer or multiple layers. For example, there may be two, three, four, or more layers. In some embodiments, the porous substrate is hydrophobic. In other embodiments, the porous substrate is hydrophilic.

If the porous substrate is asymmetric (before being combined with the polymer composition), the first and second major surfaces have porous structures with different pore morphologies. For example, the porous substrate may have pores of differing sizes throughout its thickness. Analogously, if the porous substrate is symmetric (before being combined with the polymer composition), the major surfaces have porous structures wherein their pore morphologies are the same. For example, the porous substrate may have pores of the same size throughout its thickness.

Referring to FIG. 1A, an asymmetric substrate is shown with different pore morphologies at the first major surface 18 and the second major surface 19. More specifically, there are three layers each of different pore size such that the overall substrate has pores of differing sizes throughout its thickness “T.” In certain embodiments, nanoporous layer 12 alone could function as the porous substrate. In such embodiments, the porous substrate would be symmetric.

Suitable porous substrates include, for example, films, porous membranes, woven webs, nonwoven webs, hollow fibers, and the like. For example, the porous substrates may be made of one or more layers that include films, porous films, micro-filtration membranes, ultrafiltration membranes, nanofiltration membranes, woven materials, and nonwoven materials. The materials that may be used for each of the above-mentioned supports may be organic in nature (such as the organic polymers listed below), inorganic in nature (such as aluminum, steels, and sintered metals and/or ceramics and glasses), or a combination thereof. For example, the porous substrate may be formed from polymeric materials, ceramic and glass materials, metal, and the like, or combinations (i.e., mixtures and copolymers) thereof.

In composite membranes of the present disclosure, materials that withstand hot gasoline environment and provide sufficient mechanical strength to the composite membranes are preferred. Materials having good adhesion to each other are particularly desirable. In certain embodiments, the porous substrate is preferably a polymeric porous substrate.

Suitable polymeric materials include, for example, polystyrene, polyolefins, polyisoprenes, polybutadienes, fluorinated polymers (e.g., polyvinylidene fluoride (PVDF), ethylene-co-chlorotrifluoroethylene copolymer (ECTFE), polytetrafluoroethylene (PTFE)), polyvinyl chlorides, polyesters (PET), polyamides (e.g., various nylons), polyimides, polyethers, poly(ether sulfone)s, poly(sulfone)s, poly(phenylene sulfone)s, polyphenylene oxides, polyphenylene sulfides (PPS), poly(vinyl acetate)s, copolymers of vinyl acetate, poly(phosphazene)s, poly(vinyl ester)s, poly(vinyl ether)s, poly(vinyl alcohol)s, polycarbonates, polyacrylonitrile, polyethylene terephthalate, cellulose and its derivatives (such as cellulose acetate and cellulose nitrate), and the like, or combinations (i.e., mixtures or copolymers) thereof.

Suitable polyolefins include, for example, poly(ethylene), poly(propylene), poly(l-butene), copolymers of ethylene and propylene, alpha olefin copolymers (such as copolymers of 1-butene, 1-hexene, 1-octene, and 1-decene), poly(ethylene-co-1-butene), poly(ethylene-co-1-butene-co-1-hexene), and the like, or combinations (i.e., mixtures or copolymers) thereof.

Suitable fluorinated polymers include, for example, polyvinylidene fluoride (PVDF), polyvinyl fluoride, copolymers of vinylidene fluoride (such as poly(vinylidene fluoride-co-hexafluoropropylene)), copolymers of chlorotrifluoroethylene (such as ethylene-co-chlorotrifluoroethylene copolymer), polytetrafluoroethylene, and the like, or combinations (i.e., mixtures or copolymers) thereof.

Suitable polyamides include, for example, poly(imino(1-oxohexamethylene)), poly(iminoadipoylimino hexamethylene), poly(iminoadipoyliminodecamethylene), polycaprolactam, and the like, or combinations thereof.

Suitable polyimides include, for example, poly(pyromellitimide), polyetherimide, and the like.

Suitable poly(ether sulfone)s include, for example, poly(diphenylether sulfone), poly(diphenylsulfone-co-diphenylene oxide sulfone), and the like, or combinations thereof.

Suitable polyethers include, for example, polyetherether ketone (PEEK).

Such materials may be photosensitive or non-photosensitive. Photosensitive porous substrate materials may act as a photoinitiator and generate radicals which initiate polymerization under radiation sources, such as UV radiation, so that the filled polymer or the coated polymer could covalently bond to the porous substrate. Suitable photosensitive materials include, for example, polysulfone, polyethersulfone, polyphenylenesulfone, PEEK, polyimide, PPS, PET, and polycarbonate. Photosensitive materials are preferably used for nanoporous layers.

Suitable porous substrates may have pores of a wide variety of sizes. For example, suitable porous substrates may include nanoporous membranes, microporous membranes, microporous nonwoven/woven webs, microporous woven webs, microporous fibers, nanofiber webs and the like. In some embodiments, the porous substrate may have a combination of different pore sizes (e.g., micropores, nanopores, and the like). In one embodiment, the porous substrate is microporous.

In some embodiments, the porous substrate includes pores that may have an average pore size less than 10 micrometers (μm). In other embodiments, the average pore size of the porous substrate may be less than 5 μm, or less than 2 μm, or less than 1 μm.

In other embodiments, the average pore size of the porous substrate may be greater than 10 nm (nanometer). In some embodiments, the average pore size of the porous substrate is greater than 50 nm, or greater than 100 nm, or greater than 200 nm.

In certain embodiments, the porous substrate includes pores having an average size in the range of from 0.5 nm up to and including 1000 μm. In some embodiments, the porous substrate may have an average pore size in a range of 10 nm to 10 μm, or in a range of 50 nm to 5 μm, or in a range of 100 nm to 2 μm, or in a range of 200 nm to 1 μm.

In certain embodiments, the porous substrate includes a nanoporous layer. In certain embodiments, the nanoporous layer is adjacent to or defines the first major surface of the porous substrate. In certain embodiments, the nanoporous layer includes pores having a size in the range of from 0.5 nanometer (nm) up to and including 100 nm. In accordance with the present disclosure, the size of the pores in the nanoporous layer may include, in increments of 1 nm, any range between 0.5 nm and 100 nm. For example, the size of the pores in the nanoporous layer may be in the range of from 0.5 nm to 50 nm, or 1 nm to 25 nm, or 2 nm to 10 nm, etc. Molecular Weight Cut-Off (MWCO) is typically used to correlate to the pore size. That is, for nanopores, the molecular weight of a polymer standard (retain over 90%) such as dextran, polyethylene glycol, polyvinyl alcohol, proteins, polystyrene, poly(methyl methacrylate) may be used to characterize the pore size. For example, one supplier of the porous substrates evaluates the pore sizes using a standard test, such as ASTM E1343-90-2001 using polyvinyl alcohol.

In certain embodiments, the porous substrate includes a microporous layer. In certain embodiments, the microporous layer is adjacent to or defines the first major surface of the porous substrate. In certain embodiments, the microporous layer includes pores having a size in the range of from 0.01 μm up to and including 20 μm. In accordance with the present disclosure, the size of the pores in the microporous layer may include, in increments of 0.05 μm, any range between 0.01 μm up and 20 μm. For example, the size of the pores in the microporous layer may be in the range of from 0.05 μm to 10 μm, or 0.1 μm to 5 μm, or 0.2 μm to 1 μm, etc. Typically, the pores in the microporous layer may be measured by mercury porosimetry for average or largest pore size, bubble point pore size measurement for the largest pores, Scanning Electron Microscopy (SEM) and/or Atom Force Microscopy (AFM) for the average/largest pore size.

In certain embodiments, the porous substrate includes a macroporous layer. In certain embodiments, the macroporous layer is adjacent to or defines the first major surface of the porous substrate. In certain embodiments, the macroporous layer is embedded between two microporous layers, for example a BLA020 membrane obtained from 3M Purification Inc.

In certain embodiments, the macroporous layer comprises pores having a size in the range of from 1 μm and 1000 μm. In accordance with the present disclosure, the size of the pores in the macroporous layer may include, in increments of 1 μm, any range between 1 μm up to and including 1000 μm. For example, the size of the pores in the macroporous substrate may be in the range of from 1 μm to 500 μm, or 5 μm to 300 μm, or 10 μm to 100 μm, etc. Typically, the size of the pores in the macroporous layer may be measured by Scanning Electron Microscopy, or Optical Microscopy, or using a Pore Size Meter for Nonwovens.

The macroporous layer is typically preferred at least because the macropores not only provide less vapor transport resistance, compared to microporous or nanoporous structures, but the macroporous layer can also provide additional rigidity and mechanical strength.

The thickness of the porous substrate selected may depend on the intended application of the membrane. Generally, the thickness of the porous substrate (“T” in FIG. 1A) may be greater than 10 micrometers (μm). In some embodiments, the thickness of the porous substrate may be greater than 1,000 μm, or greater than 5,000 μm. The maximum thickness depends on the intended use, but may often be less than or equal to 10,000 μm.

In certain embodiments, the porous substrate has first and second opposite major surfaces, and a thickness measured from one to the other of the opposite major surfaces in the range of from 5 μm up to and including 500 μm. In accordance with the present disclosure, the thickness of the porous substrate may include, in increments of 25 μm, any range between 5 μm and 500 μm. For example, the thickness of the porous substrate may be in the range of from 50 μm to 400 μm, or 100 μm to 300 μm, or 150 μm to 250 μm, etc.

In certain embodiments, the nanoporous layer has a thickness in the range of from 0.01 μm up to and including 10 μm. In accordance with the present disclosure, the thickness of the nanoporous layer may include, in increments of 50 nm, any range between 0.01 μm and 10 μm. For example, the thickness of the nanoporous layer may be in the range of from 50 nm to 5000 nm, or 100 nm to 3000 nm, or 500 nm to 2000 nm, etc.

In certain embodiments, the microporous layer has a thickness in the range of from 5 μm up to and including 300 μm. In accordance with the present disclosure, the thickness of the microporous layer may include, in increments of 5 μm, any range between 5 μm and 300 μm. For example, the thickness of the microporous layer may be in the range of from 5 μm to 200 μm, or 10 μm to 200 μm, or 20 μm to 100 μm, etc.

In certain embodiments, the macroporous layer has a thickness in the range of from 25 μm up to and including 500 μm. In accordance with the present disclosure, the thickness of the macroporous layer may include, in increments of 25 μm, any range between 25 μm up and 500 μm.

For example, the thickness of the macroporous substrate may be in the range of from 25 μm to 300 μm, or 25 μm to 200 μm, or 50 μm to 150 μm, etc.

In certain embodiments, there may be anywhere from one to four layers in any combination within a porous substrate. The individual thickness of each layer may range from 5 nm to 1500 μm in thickness.

In certain embodiments, each layer may have a porosity that ranges from 0.5% up to and including 95%.

### Polymer Compositions

In general, the polymer composition is insoluble in the liquids in which it comes into contact during use. More specifically, the polymer composition is more permeable to a first liquid than a second liquid. In certain embodiments, the polymer composition is not soluble in at least the mixture of first and second liquids, and preferably, the first liquid and the second liquid. As used herein, the polymer composition is considered to be insoluble (or not soluble) in the first liquid (particularly, alcohol or other high octane compounds such as aromatics) or the second liquid (particularly, gasoline or other such fuels), or a mixture thereof, even if insignificant amounts of the polymer are soluble in the liquids. In the context of the end use, the solubility of the polymer composition is insignificant if the utility and lifetime of the composite membranes are not adversely affected. Preferably, “insoluble” and “not soluble” mean there can be a small amount of solubility, as long as the membrane survives conditions of use for at least 30 hours, or at least 40 hours, or at least 50 hours, or at least 60 hours, or at least 70 hours, or at least 80 hours, or at least 90 hours, or at least 100 hours, or at least 110 hours, or at least 120 hours, or at least 125 hours, of use in a separation process.

In certain embodiments, the polymer composition is a polyvinyl lactam-containing (PVL-containing) polymer composition (embodiment “d”). “PVL-containing” means that the polymer composition may include other components, particularly polymeric components. It also means that the PVL polymer may be a PVL homopolymer or copolymer (which includes two or more different monomers). A PVL-containing polymer composition includes polyvinyl-β-propiolactam, polyvinyl-δ-valerolactam, polyvinyl-ε-caprolactam, or a combination thereof. Thus, as used herein, a PVL-containing polymer excludes polyvinyl pyrrolidone.

In certain embodiments, the polymer composition can be a polyvinyl pyrrolidone-containing (PVP-containing) polymer composition. “PVP-containing” means that the polymer composition may include other components, particularly polymeric components. PVP polymer may form an interpenetrating network (IPN) with other polymeric components if one or both are crosslinked. It also means that the PVP polymer may be a PVP homopolymer or copolymer. An exemplary PVP-containing copolymer is a PVP grafted PVA copolymer.

The polymer composition in the polymer layer of the composite membranes of the disclosure includes at least one polymer crosslinked by actininc radiation (e.g., UV, e-beam, or gamma radiation) (i.e., an actinic-radiation-crosslinked polymer) and/or at least one polymer grafted to the support substrate. In certain embodiments, the polymer composition in the polymer layer includes an interpenetrating network of two or more polymers.

The presence of a polymer crosslinked by actinic radiation (e.g., UV, e-beam, or gamma radiation) and/or the presence of a polymer grafted to the substrate provides durability to the composite membrane while maintaining acceptable overall performance (e.g., with respect to flux and selectivity), particularly when used in a gasoline fuel system.

Representative PVP- or PVL-containing copolymers include poly(vinylpyrrolidone/alkyl vinylimidazolium) such as poly(vinylpyrrolidone/methyl vinylimidazolium) (e.g., those available from BASF under the trade names “Luviquat HM 552,” “Luviquat FC370,” “Luviquat FC550,” “Luviquat Excellence,” and “Luviquat Ultracare”), poly(vinylpyrrolidone/methyacrylamide/vinylimidazole/quaternized vinylimidazole) (e.g., that available from BASF under the trade name “Luviquat Supreme”), poly(vinylcaprolactam/vinylpyrrolidone/quaternized vinylimidazole) (e.g., that available from BASF under the trade name “Luviquat Hold”), poly(vinylpyrrolidone/dimethylaminoethyl methacrylate) (e.g., that available from BASF under the trade name “Luviquat PQ 11” or those available from Ashland Inc. under the trade names “GAFQUAT copolymer-755” or VP/DMAEMA copolymer 845, 937, and 958), poly(vinylcarprolactam/vinylpyrrolidone/dimethylaminopropyl methacrylamide) (e.g., that available from Ashland Inc. under the trade name “AQUAFLEX Copolymer-SF-40”), poly(vinylcaprolactam/vinylpyrrolidone/dimethylaminoethylmethacrylate) (e.g., those available from Ashland Inc. under the trade names “ADVANTAGE Copolymers-LC-A” and “Gaffix terpolymers-VC-713”), poly(vinylpyrrolidone/dimethylamino propylmethacrylamide/methyacryloylaminopropyl lauryl dimethyl ammonium chloride) (e.g., those available from Ashland Inc. under the trade names “STYLEZE Copolymer-W-10,” “STYLEZE Copolymer-W-20,” and “STYLEZE 2000”), poly(vinylpyrrolidone/dimethylaminopropylmethacrylamide) (e.g., those available from Ashland Inc. under the trade names “STYLEZE CC-10” and “SETLEZE 3000”), poly(vinylpyrrolidone/methacrylamidopropyltrimethylammonium chloride) (e.g., those available from Ashland Inc. under the trade name “Gafquat HS-100” polymers), poly(vinylpyrrolidone/acrylic acid) (e.g. ULTRA THIN P-100 polymer from Ashland Inc.), poly(vinylpyrrolidone/vinyl acetate) (e.g., those available from Ashland Inc. under the trade names PVP/VA copolymer E-735, 1-735, W-735, W-635, S-630, E-535, I-535, E-335, I-335, and that available from BASF under the trade name “KOLLIDON VA64”).

Representative PVP-containing copolymers include also graft copolymers of vinyl pyrrolidone, for example, alkylated PVP (e.g., such as those available from Ashland Inc. under the trade names ANTARON or GANEX P-904LC, V-216, V-516, V-220, and WP-660).

Other PVP-containing copolymers include poly(vinylpyrrolidone/alkylacrylate) and poly(vinylpyrrolidone/vinylamine).

In certain embodiments, PVP- or PVL-containing copolymers include positively charged components, with accompanying anions including, Cl⁻, Br⁻, I⁻, HSO₄⁻, NO₃⁻, SO₄²⁻, CF₃SO₃⁻, N(SO₂CF₃)₂⁻, CH₃SO₃⁻, B(CN)₄⁻, C₄F₉SO₃⁻, PF₆⁻, N(CN)₄⁻, C(CN)₄⁻, BF₄⁻, Ac⁻, SCN⁻, HSO₄⁻, CH₃SO₄⁻, C₂H₅SO₄⁻, and C₄H₉SO₄⁻.

In certain embodiments, the PVP- or PVL-containing copolymers include poly(vinylpyrrolidone/alkyl vinylimidazolium), poly(vinylpyrrolidone/methyacrylamide/vinylimidazole/quaternized vinylimidazole), poly(vinylcaprolactam/vinylpyrrolidone/quaternized vinylimidazole), poly(vinylcarprolactam/vinylpyrrolidone/dimethylaminopropyl methacrylamide), poly(vinylpyrrolidone/dimethylamino propylmethacrylamide/methyacryloylaminopropyl lauryl dimethyl ammonium chloride), poly(vinylpyrrolidone/dimethylaminopropylmethacrylamide), poly(vinylpyrrolidone/methacrylamidopropyltrimethylammonium chloride), poly(vinylpyrrolidone/acrylic acid), poly(vinylpyrrolidone/vinyl acetate), graft copolymers of vinyl pyrrolidone, poly(vinylpyrrolidone/vinylamine), and combinations thereof.

In certain embodiments, the PVP- or PVL-containing copolymers include poly(vinylpyrrolidone/alkyl vinylimidazolium), poly(vinylpyrrolidone/methyacrylamide/vinylimidazole/quaternized vinylimidazole), poly(vinylcaprolactam/vinylpyrrolidone/quaternized vinylimidazole), and combinations thereof.

In certain embodiments, the PVP- or PVL-containing copolymers include poly(vinylpyrrolidone/alkyl vinylimidazolium) such as poly(vinylpyrrolidone/methyl vinylimidazolium).

In certain embodiments, PVP- or PVL-containing polymers may be crosslinked by, for example, UV radiation, electron beam radiation, and gamma radiation.

In certain embodiments, PVP- or PVL-containing polymers form an interpenetrating network with a second polymer, particularly a crosslinked polymer.

In certain embodiments, the PVP-containing polymer composition or the PVL-containing polymer composition is formed prior to contact with the porous substrate.

In certain embodiments, the PVP or PVL-containing polymer compositions include polymers having a molecular weight of at least 1,000 Daltons, and up to 10,000,000 Daltons.

The PVL-containing polymer compositions may be disposed in and/or on the porous substrate.

In certain embodiments, the PVP-containing polymer is not a pore-filling polymer composition (embodiment “a”). By this it is meant that the PVP-containing polymer composition does not penetrate significantly into the pores of the porous substrate. That is, a majority of polymer composition is on top of the substrate. If PVP blends with polymerizable compounds, PVP compositions can be coated first, followed by coating polymeriazable compounds and curing.

In certain embodiments, the PVP-containing polymer composition includes greater than 75 wt-% PVP (embodiment “b”). Such PVP-containing polymer composition may be disposed in and/or on the porous substrate.

In certain embodiments, the PVP-containing polymer composition includes one or more additional polymers but does not include a polymer derived from one or more ethylenically unsaturated monomers and/or oligomers (embodiment “c”). Such PVP-containing polymer composition may be disposed in and/or on the porous substrate.

In the PVP-containing polymer compositions that do not include a polymer derived from one or more ethylenically unsaturated monomers and/or oligomers (embodiment “c”), such monomers and oligomers include (meth)acrylate-containing monomers and/or oligomers. (Meth)acrylate-containing monomers and/or oligomers that form polymers that are not included within the PVP-containing polymer compositions include polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, a urethane diacrylate, a urethane hexa-acrylate, a urethane triacrylate, a polymeric tetrafunctional acrylate, a polyester penta-acrylate, an epoxy diacrylate, a polyester triacrylate, a polyester tetra-acrylate, an amine-modified polyester triacrylate, an alkoxylated aliphatic diacrylate, an ethoxylated bisphenol di(meth)acrylate, a propoxylated triacrylate, and 2-acrylamido-2-methylpropanesulfonic acid (AMPS). Other (meth)acrylate-containing monomers and/or oligomers that form polymers that are not included within the PVP-containing polymer compositions include polyethylene glycol (meth)acrylate, a polyethylene glycol di(meth)acrylate, a silicone diacrylate, a silicone hexa-acrylate, a polypropylene glycol di(meth)acrylate, an ethoxylated trimethylolpropane triacrylate, a hydroxylmethacrylate, 1H,1H,6H,6H-perfluorohydroxyldiacrylate, and a polyester tetra-acrylate. (Meth)acrylate-containing monomers and/or oligomers that form polymers that are not included within the PVP-containing polymer compositions include one or more of the following:

(a) di(meth)acryl-containing compounds such as dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, and tripropylene glycol diacrylate;
(b) tri(meth)acryl-containing compounds such as trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), and trimethylolpropane triacrylate;
(c) higher functionality (meth)acryl-containing compounds (i.e., higher than tri-functional) such as ditrimethylolpropane tetraacrylate, dipentaerythritol pentaacrylate, ethoxylated (4) pentaerythritol tetraacrylate, pentaerythritol tetraacrylate, and caprolactone modified dipentaerythritol hexaacrylate;
(d) oligomeric (meth)acryl compounds such as, for example, urethane acrylates, polyester acrylates, epoxy acrylates, silicone acrylates, polyacrylamide analogues of the foregoing, and combinations thereof (such compounds are widely available from vendors such as, for example, Sartomer Company, Exton, Pa., UCB Chemicals Corporation, Smyrna, Ga., and Aldrich Chemical Company, Milwaukee, Wis.);
(e) perfluoroalkyl meth(acryl)-containing compounds such as 1H,1H,6H,6H-perfluorohydroxyldiacrylate, 1H,1H-2,2,3,3,4,4,4-heptafluorobutyl acrylate, and perfluorocyclohexyl)methyl acrylate;
(f) charged meth(acryl)-containing compounds such as acrylic acid, 2-acrylamido-2-methylpropanesulfonic acid (AMPS), and [3-(methacryloylamino)propyl]trimethylammonium chloride solution; and
(g) polar polymerizable compounds such as 2-hydroxyethyl(meth)acrylate (HEMA), N-vinyl acetamide, (meth)acrylamide, and glycerol methacrylate.

The polymer composition may be crosslinked. The crosslinking may be physical crosslinking and/or chemical crosslinking such as, e.g., in the form of an interpenetrating network (IPN). It may be grafted to the porous (substrate) membrane (e.g., which may be in the form of a nanoporous layer). Or, it may be crosslinked and grafted to the porous substrate (e.g., nanoporous layer).

In certain embodiments, the polymer composition may swell in the presence of alcohol (e.g., ethanol) and/or other high octane compounds (e.g., aromatic compounds) but not gasoline and/or other such fuels. When the polymer composition swells in the presence of the alcohol or other high octane compound, the resultant swollen polymer may be referred to as a gel.

### Optional Ionic Liquids

In certain embodiments, separation membranes of the present disclosure further include one or more ionic liquids mixed in the polymer composition.

Such composite membranes demonstrate improved performance (e.g., flux) over the same separation membranes without the ionic liquids. Improved performance may be demonstrated by increased flux while maintaining good high octane compound (e.g., alcohol, such as ethanol) selectivity.

An ionic liquid (i.e., liquid ionic compound) is a compound that is a liquid under separation conditions. It may or may not be a liquid during mixing with the polymer composition, application to a substrate, storage, or shipping. In certain embodiments, the desired ionic liquid is liquid at a temperature of less than 100° C., and in certain embodiments, at room temperature.

Ionic liquids are salts in which the cation(s) and anion(s) are poorly coordinated. At least one of the ions is organic and at least one of the ions has a delocalized charge. This prevents the formation of a stable crystal lattice, and results in such materials existing as liquids at the desired temperature, often at room temperature, and at least, by definition, at less than 100° C.

In certain embodiments, the ionic liquid includes one or more cations selected from quaternary ammonium, imidazolium, pyrazolium, oxazolium, thiazolium, triazolium, pyridinium, piperidinium, pyridazinium, pyrimidinium, pyrazinium, pyrrolidinium, phosphonium, trialkylsulphonium, pyrrole, and guanidium.

In certain embodiments, the ionic liquid includes one or more anions selected from Cl⁻, Br⁻, I⁻, HSO₄⁻, NO₃⁻, SO₄²⁻, CF₃SO₃⁻, N(SO₂CF₃)₂⁻, CH₃SO₃⁻, B(CN)₄⁻, C₄F₉SO₃⁻, PF₆⁻, N(CN)₄⁻, C(CN)₄⁻, BF₄⁻, Ac⁻, SCN⁻, HSO₄⁻, CH₃SO₄⁻, C₂H₅SO₄⁻, and C₄H₉SO₄⁻.

In certain embodiments, the ionic liquid is selected from 1-ethyl-3-methyl imidazolium tetrafluoroborate (Emim-BF₄), 1-ethyl-3-methyl imidazolium trifluoromethane sulfonate (Emim-TFSA), 3-methyl-N-butyl-pyridinium tetrafluoroborate, 3-methyl-N-butyl-pyridinium trifluoromethanesulfonate, N-butyl-pyridinium tetrafluoroborate, 1-butyl-2,3-dimethylimidazolium tetrafluoroborate, 1-butyl-2,3-dimethylimidazolium trifluoromethanesulfonate, 1-ethyl-3-methylimidazolium chloride, 1-butyl-3-ethylimidazolium chloride, 1-butyl-3-methylimidazolium chloride, 1-butyl-3-methylimidazolium bromide, 1-methyl-3-propylimidazolium chloride, 1-methyl-3-hexylimidazolium chloride, 1-methyl-3-octylimidazolium chloride, 1-methyl-3-decylimidazolium chloride, 1-methyl-3-dodecylimidazolium chloride, 1-methyl-3-hexadecylimidazolium chloride, 1-methyl-3-octadecylimidazolium chloride, 1-ethylpyridinium bromide, 1-ethylpyridinium chloride, 1-butylpyridinium chloride, and 1-benzylpyridinium bromide, 1-butyl-3-methylimidazolium iodide, 1-butyl-3-methylimidazolium nitrate, 1-ethyl-3-methylimidazolium bromide, 1-ethyl-3-methylimidazolium iodide, 1-ethyl-3-methylimidazolium nitrate, 1-butylpyridinium bromide, 1-butylpyridinium iodide, 1-butylpyridinium nitrate, 1-butyl-3-methylimidazolium hexafluorophosphate, 1-octyl-3-methylimidazolium hexafluorophosphate, 1-octyl-3-methylimidazolium tetrafluoroborate, 1-ethyl-3-methylimidazolium ethylsulfate, 1-butyl-3-methylimidazolium acetate, 1-butyl-3-methylimidazolium trifluoroacetate, 1-butyl-3-methyl imidazolium bis(trifluormethylsulfonyl)imide (Bmim-Tf₂N), and combinations thereof

### Optional Fluorochemical Films

In certain embodiments, composite membranes of the present disclosure further include an amorphous fluorochemical film disposed on the separation membrane. Typically, the film is disposed on the side of the separation membrane the feed mixture enters.

In certain embodiments, the amorphous fluorochemical film is deposited on top of the porous substrate so as to protect the pore-filling polymer. The amorphous fluorochemical film may fill a portion of the porous substrate's pores above the pore filling polymer.

In certain embodiments, such separation membranes demonstrate improved durability over the same separation membranes without the amorphous fluorochemical film. Improved durability may be demonstrated by reduced mechanical damage (e.g., abrasions, scratches, erosion, or crack generation upon membrane folding), reduced fouling, reduced chemical attack, and/or reduced performance decline after exposure to gasoline or ethanol/gasoline mixture under separation conditions.

In certain embodiments, such separation membranes demonstrate improved performance over the same separation membranes without the amorphous fluorochemical film. Improved performance may be demonstrated by increased flux.

In certain embodiments, such amorphous fluorochemical film typically has a thickness of at least 0.001 μm, or at least 0.03 μm. In certain embodiments, such amorphous fluorochemical film typically has a thickness of up to and including 5 μm, or up to and including 0.1 μm.

In certain embodiments, the amorphous fluorochemical film is a plasma-deposited fluorochemical film, as described in U.S. Pat. Pub. 2003/0134515.

In certain embodiments, the plasma-deposited fluorochemical film is derived from one or more fluorinated compounds selected from: linear, branched, or cyclic saturated perfluorocarbons; linear, branched, or cyclic unsaturated perfluorocarbons; linear, branched, or cyclic saturated partially fluorinated hydrocarbons; linear, branched, or cyclic unsaturated partially fluorinated hydrocarbons; carbonyl fluorides; perfluorohypofluorides; perfluoroether compounds; oxygen-containing fluorides; halogen fluorides; sulfur-containing fluorides; nitrogen-containing fluorides; silicon-containing fluorides; inorganic fluorides (such as aluminum fluoride and copper fluoride);

and rare gas-containing fluorides (such as xenon difluoride, xenon tetrafluoride, and krypton hexafluoride).

In certain embodiments, the plasma-deposited fluorochemical film is derived from one or more fluorinated compounds selected from CF₄, SF₆, C₂F₆, C₃F₈, C₄F₁₀, C₅F₁₂, C₆F₁₄, C₇F₁₆, C₈F₁₈, C₂F₄, C₃F₆, C₄F₈, C₅F₁₀, C₆F₁₂, C₄F₆, C₇F₁₄, C₈F₁₆, CF₃COF, CF₂(COF)₂, C₃F₇COF, CF₃OF, C₂F₅OF, CF₃COOF, CF₃OCF₃, C₂F₅OC₂F₅, C₂F₄OC₂F₄, OF₂, SOF₂, SOF₄, NOF, ClF₃, IF₅, BrF₅, BrF₃, CF₃I, C₂F₅I, N₂F₄, NF₃, NOF₃, SiF₄, SiF₄, Si₂F₆, XeF₂, XeF₄, KrF₂, SF₄, SF₆, monofluorobenzene, 1,2-difluorobenzene, 1,2,4-trifluorobenzene, pentafluorobenzene, pentafluoropyridine, and pentafluorotolenene.

In certain embodiments, the plasma-deposited fluorochemical film is derived from one or more hydrocarbon compounds in combination with one or more fluorinated compounds. Examples of suitable hydrocarbon compounds include acetylene, methane, butadiene, benzene, methylcyclopentadiene, pentadiene, styrene, naphthalene, and azulene.

Typically, fluorocarbon film plasma deposition occurs at rates ranging from 1 nanometer per second (nm/sec) to 100 nm/sec depending on processing conditions such as pressure, power, gas concentrations, types of gases, and the relative size of the electrodes. In general, deposition rates increase with increasing power, pressure, and gas concentration. Plasma is typically generated with RF electric power levels of at least 500 watts and often up to and including 8000 watts, with a typical moving web speed or at least 1 foot per minute (fpm) (0.3 meter per minute (m/min) and often up to and including 300 fpm (90 m/min). The gas flow rates, e.g., of the fluorinated compound and the optional hydrocarbon compound, is typically at least 10 (standard cubic centimeters per minutes) sccm and often up to and including 5,000 sccm. In some embodiment, the fluorinated compound is carried by an inert gas such as argon, nitrogen, helium, etc.

In certain embodiments, the amorphous fluorochemical film includes an amorphous glassy perfluoropolymer having a Tg (glass transition temperature) of at least 100° C.

Examples of suitable amorphous glassy perfluoropolymers include a copolymer of perfluoro-2,2-dimethyl-1,3-dioxole (PDD) and polytetrafluoroethylene (TFE) (such as those copolymers available under the trade names TEFLON AF2400 and TEFLON AF1600 from DuPont Company), a copolymer of 2,2,4-trifluoro-5-trifluoromethoxy-1,3-dioxole (TTD) and TFE (such as those copolymers available under the trade names HYFLON AD60 and HYFLON AD80 from Solvay Company), and a copolymer of TFE and cyclic perfluoro-butenylvinyl ether (such as the copolymer available under the trade name CYTOP from Asahi Glass, Japan).

In certain embodiments, such amorphous glassy perfluoropolymer is a perfluoro-dioxole homopolymer or copolymer such as a copolymer of perfluoro-2,2-dimethyl-1,3-dioxole (PDD) and polytetrafluoroethylene (TFE), and a copolymer of 2,2,4-trifluoro-5-trifluoromethoxy-1,3-dioxole (TTD) and TFE.

In certain embodiments, such amorphous glassy perfluoropolymer is deposited out of solution. Exemplary solvents for use in deposition of the amorphous glassy perfluoropolymer include those available from 3M Company under the trade names FLUORINERT FC-87, FC-72, FC-84, and FC-770, as well as NOVEC HFE-7000, HFE-7100, HFE-7200, HFE-7300, and HFE-7500.

### Methods of Making Composite Membranes

In certain embodiments, the polymer compositions described herein are typically applied out of a solution or dispersion of the desired (pre-polymerized) PVP-containing or PVL-containing polymer in a suitable amount of a liquid (e.g., deionized water or organic solvents). If an organic solvent is used, it may include methanol, ethanol, propanol, isopropanol, 1-methoxyl-2-propanol, dibutyl sebecate, glycerol triacetate, acetone, methyl ethyl ketone etc.

By careful selection of the concentration of the coating solution or dispersion, the molecular weight and/or particle size of the PVP- or PVL-containing polymer and additives, and the substrate pore structure so that the polymer composition remains substantially on the surface, or penetrates substrate pores, or a combination of both, can be controlled. Subsequent drying, curing (e.g., by UV or electron beam irradiation), crosslinking, or grafting all the applied polymer composition is preferred so that only an insignificant amount is washed out and wasted.

The coating process of a pre-polymerized polymer may be more controllable than a coating process that includes applying a polymerizable composition that is polymerized in situ.

Typically, a polymerizable pore-filling polymer composition (that is polymerized in situ) may be applied to a selected porous substrate by a variety of techniques such as saturation or immersion techniques (e.g., dip coating), knife coating, slot coating, slide coating, curtain coating, rod or bar coating, roll coating, gravure coating, spin coating, spraying coating, etc. In certain situations, subsequent polymerization and removal of unpolymerized pore-filling material may lead to waste and less control over placement of the polymer composition. For example, in a “dip and squeeze” method, the substrate to be coated is run through a pan of coating solution and then excess coating solution squeezed out by running the substrate between a pair of nip rolls. Excess solution is typically applied than is needed to stay on the finished membrane. The excess solution often penetrates to the porous substrate (e.g., macroporous layer of the substrate) where it will not produce any beneficial separation. Excess polymer application can reduce flux. Thus, in certain situations, the intent is to apply just enough polymer to achieve the desired level of selectivity and not so much that flux is significantly reduced. In certain situations, the application of a polymerizable material can increase the cost of production, increase waste, and may be difficult to control the amount and placement of the polymer.

In certain embodiments, a polymer composition-containing solution (that may include polymerizable components) may be applied on top of a selected porous substrate by a variety of techniques such as surface contact dip coating, knife coating, slot coating, slide coating, curtain coating, rod or bar coating, roll coating, gravure coating, spin coating, spraying coating, etc. In certain embodiments, the polymer composition-containing solution is delivered in predetermined amount so that the deposited polymer composition thickness can be well controlled. In certain embodiments, the solvent in the polymer composition containing solution is removed by evaporation for example, passing through a drying oven with sweeping gas and/or at elevated temperature, before irradiation. In other embodiments, some solvent residues remain in composite membranes right before irradiation.

In certain embodiments, one or more photoinitiators are mixed into polymer composition-containing solutions before applying onto a porous substrate. In other embodiments, one or more photoinitiators are applied onto a polymer composition composite membrane in a separate process and then irradiated with a high energy source.

In certain embodiments, the composite membrane is not washed before its use. In other embodiments, the composite membrane is washed to remove uncured polymerizable components and/or any components that are leachable when exposed to the liquid feed mixture.

Using a method that applies a pre-polymerized polymer may result in many aspects of the coating process being more readily controlled. This can include, for example: the amount of coating composition applied; the location of the coating composition applied; migration of the coating after being applied (on one surface, both surfaces or penetrating into the substrate); the amount and depth of crosslinking and/or grafting; the amount of coating composition not crosslinked, cured, or grafted to the substrate; the amount of waste. Thus, control of each of these steps by applying a pre-polymerized polymer may have an impact on the consistency of final membrane flux, selectivity, and durability.

Either an ionic liquid could be mixed in the coating composition and applied to the porous support at one pass, or an ionic liquid dissolved in a solvent can be over-coated onto the PVP- or PVL-containing polymer coated membrane. The ionic liquid may diffuse into the PVP- or PVL-containing polymer layer.

An amorphous fluorocarbon film may be applied after the PVP- or PVL-containing polymer composition is coated in or on a substrate. The fluorocarbon film can be formed out of a solution or deposited by plasma fluorination.

Commercially available porous substrates may be supplied with a humectant, such as glycerol, that fills and/or coats the pores of the substrate. Typically, this is done to prevent small pores from collapsing during drying process and storage, for example. This humectant may or may not be washed out before using. Preferably, a substrate is obtained and used without a humectant. Commercially available porous substrates also may be supplied as wet with water and/or preservative(s). Preferably, a dry substrate is used.

### Uses

Composite membranes, particularly asymmetric composite membranes, of the present disclosure may be used in various separation methods. Such separation methods include pervaporation, vapor permeation, gas separation, nanofiltration, organic solvent nanofiltration, and combinations thereof (e.g., a combination of pervaporation and vapor permeation). The composite membranes, particularly the asymmetric composite membranes, of the present disclosure are particularly useful in pervaporation methods. Pervaporation may be used for desulfurization of gasoline, dehydration of organic solvents, isolation of aroma components, and removal of volatile organic compounds from aqueous solutions.

Preferred methods of the present disclosure involve use of the composite membranes, particularly the asymmetric composite membranes, in pervaporation, particularly pervaporating alcohol from an alcohol and gasoline mixture, or other high octane compounds (those organic compounds having an octane rating of at least 87 (AKI)) from a fuel that includes such high octane compounds (e.g., gasoline). This latter method results in concentrating high octane compounds for later use.

Well-known separation techniques may be used with the composite membranes of the present disclosure. For example, nanofiltration techniques are described in U.S. Pat. Pub. No. 2013/0118983 (Linvingston et al.), U.S. Pat. No. 7,247,370 (Childs et al.), and U.S. Pat. Pub. No. 2002/0161066 (Remigy et al.). Pervaporation techniques are described in U.S. Pat. No. 7,604,746 (Childs et al.) and EP 0811420 (Apostel et al.). Gas separation techniques are described in Journal of Membrane Sciences, vol. 186, pages 97-107 (2001).

Pervaporation separation rate is typically not constant during a depletion separation. The pervaporation rate is higher when the feed concentration of the selected material (for example, ethanol) is higher than near the end of the separation when the feed concentration of the selected material is lower and this rate is typically not linear with concentration. At high feed concentration the separation rate is high and the feed concentration of the selected material and flux falls rapidly, but this concentration and flux changes very slowly as the limit of depletion is reached.

Typical conditions used in separation methods of the present disclosure include fuel temperatures of from −20° C. (or from 20° C. or from room temperature) up to and including 120° C. (or up to and including 95° C.), fuel pressures of from 10 pounds per square inch (psi) (69 kPa) up to and including 400 psi (2.76 MPa) (or up to and including 100 psi (690 kPa)), fuel flow rates of 0.1 liter per minute (L/min) up to and including 20 L/min, and vacuum pressures from 20 Torr (2.67 kPa) to and including ambient pressure (i.e., 760 Torr (101 kPa)).

The performance of a composite membrane is mainly determined by the properties of the polymer composition disposed in or on the porous (support) membrane.

The efficiency of a pervaporation membrane may be expressed as a function of its selectivity and of its specific flux. The selectivity is normally given as the ratio of the concentration of the better permeating component to the concentration of the poorer permeating component in the permeate, divided by the corresponding concentration ratio in the feed mixture to be separated:

α=(y_{w}/yᵢ)/(x_{w}/xᵢ)

wherein y_{w} and yᵢ are the content of each component in the permeate, and x_{w} and xᵢ are the content of each component in the feed, respectively. Sometimes, the permeate concentration is defined as the separation efficiency if the feed component is relatively consistent.

The trans-membrane flux is a function of the composition of the feed. It is usually given as permeate amount per membrane area and per unit time, e.g., kilogram per meter squared per hour (kg/m²/hr).

In certain embodiments of the present disclosure, the PVP- or PVL-containing polymer composition exhibits a high octane compound (e.g., an alcohol) selectivity in the range of from at least 30% up to and including 100%. In this context, “high octane compound selectivity” (e.g., “alcohol selectivity”) means the amount of high octane compound (e.g., alcohol) in the gasoline (or other such fuel)/high octane compound (e.g., alcohol) mixture that diffuses through to the output side of the asymmetric composite membrane. In accordance with the present disclosure, the high octane compound (e.g., alcohol) selectivity of the PVP- or PVL-containing (e.g., pore-filling) polymer may include, in increments of 1%, any range between 30% and 100%. For example, the high octane compound (e.g., alcohol) selectivity may be in the range of from 31% up to 99%, or 40% to 100%, or 50% to 95%, etc.

In certain embodiments, the polymer composition in the composite membrane exhibits an average high octane compound (e.g., alcohol) permeate flux, e.g., from a high octane compound/fuel mixture (e.g., an alcohol/gasoline mixture) in the range of from at least 0.2 kg/m²/hr (in certain embodiments, at least 0.3 kg/m²/hr), and in increments of 10 g/m²/hr, up to and including 30 kg/m²/hr. For example, the average ethanol flux from E10 (10% ethanol) to E2 (2% ethanol) standard include in the range of from 0.2 kg/m²/hr to 20 kg/m²/hr. Preferred processing conditions used for such flux measurement include: a feed temperature of from −20° C. (or from 20° C.) up to and including 120° C. (or up to and including 95° C.), a permeate vacuum pressure from 20 Torr (2.67 kPa) to and including 760 Torr (101 kPa), a feed pressure of from 10 psi (69 kPa) up to and including 400 psi (2.76 MPa) (or up to and including 100 psi (690 kPa)). For example, these processing conditions would be suitable for an alcohol (e.g., ethanol) concentration in feed gasoline of from 2% up to and including 20%.

In certain embodiments of the present disclosure, the PVP- or PVL-containing polymer composition in the composite membrane can exhibit an average high octane compound (e.g., ethanol) permeate flux, in increments of 10 g/m²/hour, between the below-listed upper and lower limits (according to Method 1 and/or Method 2 in the Examples Section). In certain embodiments, the average high octane compound (e.g., ethanol) permeate flux may be at least 100 g/m²/hour, or at least 150 g/m²/hour, or at least 200 g/m²/hour, or at least 250 g/m²/hour, or at least 300 g/m²/hour, or at least 350 g/m²/hour, or at least 400 g/m²/hour, or at least 450 g/m²/hour, or at least 500 g/m²/hour, or at least 550 g/m²/hour, or at least 600 g/m²/hour, or at least 650 g/m²/hour, or at least 700 g/m²/hour, or at least 750 g/m²/hour, or at least 800 g/m²/hour, or at least 850 g/m²/hour, or at least 900 g/m²/hour, or at least 950 g/m²/hour, or at least 1000 g/m²/hour. In certain embodiments, the average high octane compound (e.g., alcohol such as ethanol) permeate flux may be up to 30 kg/m²/hour, or up to 25 kg/m²/hour, or up to 20 kg/m²/hour, or up to 15 kg/m²/hour, or up to 10 kg/m²/hour, or up to 5 kg/m²/hour. For example, the average ethanol permeate flux may be in the range of from 300 g/m²/hour up to 20 kg/m²/hour, or 350 g/m²/hour up to 20 kg/m²/hour, or 500 g/m²/hour up to 10 kg/m²/hour, etc. It may be desirable for the PVP- or PVL-containing polymer composition to exhibit an average ethanol permeate flux of at least 320 g/m²/hour, when the asymmetric composite membrane is assembled into 5 liter volume cartridge such that the cartridge will produce the desired amount of flux to meet the system requirements. The system requirements are defined by internal combustion engines that require ethanol flux. One example is a Japan Society of Automotive Engineers technical paper JSAE 20135048 titled “Research Engine System Making Effective Use of Bio-ethanol-blended Fuels.”

Preferred processing conditions used for such flux measurement include: a feed temperature of from −20° C. (or from 20° C.) up to and including 120° C. (or up to and including 95° C.), a permeate vacuum pressure from 20 Torr (2.67 kPa) to and including 760 Torr (101 kPa), a feed pressure of from 10 psi (69 kPa) up to and including 400 psi (2.76 MPa) (or up to and including 100 psi (690 kPa)). For example, these processing conditions would be suitable for an ethanol concentration in feed gasoline of from 2% up to and including 20%.

Composite membranes of the present disclosure may be incorporated into cartridges (i.e., modules), in particular cartridges for separating alcohol and/or other high octane compounds from mixtures that include gasoline or other such fuels. Suitable cartridges include, for example, spiral-wound modules, plate and frame modules, tubular modules, hollow fiber modules, pleated cartridge, and the like.

FIG. 2 is an illustration of an exemplary module 120 (specifically, a spiral-wound module) that includes a support tube 122, an exemplary composite membrane 124 of the present disclosure wound onto the support tube 122. During use, a mixture of liquids to be separated (e.g., alcohol and gasoline mixture) enters the module 120 and flows along the direction of arrows 126 into the composite membrane 124. As the mixture flows past the composite membrane layers, the liquid that is less permeable in the PVP or PVL containing polymer (e.g., gasoline or other such fuels) is not absorbed, while the more permeable liquid (e.g., alcohol and/or aromatics) is absorbed in and passes through the PVP- or PVL-containing polymer and then flows out of the center of the support tube 122 along the direction of arrow 128. For example, a high concentration of alcohol (typically with a small amount of gasoline), which is separated from an alcohol/gasoline mixture, flows out of the center of the support tube 122 as vapor and/or liquid along the direction of arrow 128, and the resultant mixture with a lower concentration of alcohol than present in the mixture that enters the composite membrane flows out of the composite membrane along the direction of arrows 129.

In certain embodiments, an exemplary cartridge has a volume in the range of from 200 milliliters (mL), or 500 mL, up to and including 5.000 liters (L). In accordance with the present disclosure, the volume of the cartridge may include, in increments of 10 mL, any range between 200 mL, or 500 mL, and 5.000 L. For example, the cartridge volume may be in the range of from 210 mL up to 4.990 L, or 510 mL up to 4.990 L, or 300 mL up to 5.000 L, or 600 mL up to 5.000 L, or 1.000 L up to 3.000 L, etc. In certain embodiments, the cartridge has a volume of 1.000 L. In certain embodiments, the cartridge has a volume of 0.800 L

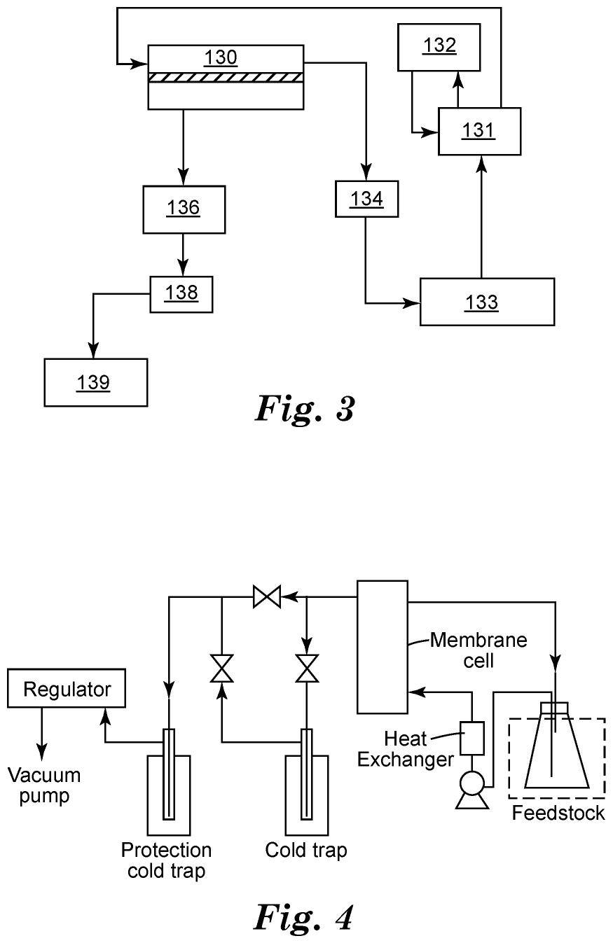

Cartridges that include composite membranes (e.g., asymmetric composite membranes) of the present disclosure may be incorporated into fuel separation systems, which may be used in, or in conjunction with, engines such as flex-fuel engines. An exemplary fuel separation system is shown in FIG. 3, which employs a membrane pervaporation method (PV method) to separate high ethanol fraction gasoline from gasoline containing ethanol. Typically, gasoline is introduced into an inlet of a membrane separation unit 130 after being passed through a heat exchanger 131 (which is connected to engine coolant 132) from a main fuel storage tank 133. A low-ethanol fraction fuel from the membrane separation unit 130 is returned to the main fuel storage tank 133 after being cooled as it passes through a radiator 134. The ethanol rich vapor which came out of membrane separation unit 130 is typically passed through a condenser 136 where it is condensed under negative pressure produced by vacuum pump 138 and then collected in an ethanol tank 139.

In certain embodiments, a fuel separation system includes one or more cartridges, which may be in series or parallel, which include composite membranes of the present disclosure.

### EXEMPLARY EMBODIMENTS

Embodiment 1 is a composite membrane for selectively separating (e.g., pervaporating) a first fluid (e.g., first liquid such as an alcohol or other high octane compound) from a feed mixture comprising the first fluid (e.g., first liquid) and a second fluid (e.g., second liquid such as gasoline), the composite membrane comprising: a porous substrate comprising opposite first and second major surfaces, and a plurality of pores; and a polymer composition, wherein the polymer composition is:

(a) a PVP-containing polymer composition that is not a pore-filling polymer composition;

(b) a PVP-containing polymer composition comprising greater than 75 wt-% PVP, wherein the PVP-containing polymer composition is in and/or on the porous substrate;

(c) a PVP-containing polymer composition comprising one or more additional polymers that does not include a polymer derived from one or more ethylenically unsaturated monomers and/or oligomers, wherein the PVP-containing polymer composition is in and/or on the porous substrate; or

(d) a PVL-containing polymer composition disposed in and/or on the porous substrate; wherein the polymer composition forms a polymer layer having a thickness;

wherein the polymer composition is more permeable to the first fluid (e.g., first liquid) than the second fluid (e.g., second liquid); and

wherein the polymer composition in the polymer layer comprises at least one polymer crosslinked with actinic radiation and/or at least one polymer grafted to the porous substrate.

Embodiment 2 is the composite membrane according to embodiment 1 wherein the polymer composition forms a polymer layer on the first major surface of the porous substrate wherein a majority of the polymer composition is on the surface of the porous substrate.

Embodiment 3 is the composite membrane according to embodiment 1 or 2 wherein one or all of polymer compositions (b), (c), and (d) are pore-filling polymer compositions disposed in at least some of the pores so as to form a layer having a thickness within the porous substrate.

Embodiment 4 is the composite membrane according to embodiment 3 wherein the pore-filling polymer composition is in the form of a pore-filling polymer layer that forms at least a portion of the first major surface of the porous substrate.

Embodiment 5 is the composite membrane according to any one of embodiments 1 through 4 which is asymmetric or symmetric with respect to the amount of polymer composition.

Embodiment 6 is the composite membrane according to embodiment 5 wherein the amount of the polymer composition at, on, or adjacent to the first major surface of the porous substrate is greater than the amount of the polymer composition at, on, or adjacent to the second major surface of the porous substrate.

Embodiment 7 is the composite membrane according to any one of embodiments 3 through 6 wherein the pore-filling polymer composition is in the form of a pore-filling polymer layer having an exposed major surface, which coats the first major surface of the porous substrate, and an opposite major surface disposed between the opposite first and second major surfaces of the porous substrate.

Embodiment 8 is the composite membrane according to embodiment 7 wherein the exposed major surface of the pore-filling polymer layer coats all the first major surface of the porous substrate.

Embodiment 9 is the composite membrane according to any one of embodiments 1 through 8 wherein the first fluid (e.g., first liquid) is an alcohol and/or other high octane compounds such as aromatic hydrocarbons.

Embodiment 10 is the composite membrane according to any one of embodiments 1 through 9 wherein the second fluid (e.g., second liquid) is gasoline.

Embodiment 11 is the composite membrane according to embodiment 10 wherein the first fluid (e.g., first liquid) is an alcohol, and the second fluid (e.g., second liquid) is gasoline.

Embodiment 12 is the composite membrane according to any one of embodiments 1 through 11 wherein the polymer layer forms a continuous layer.

Embodiment 13 is the composite membrane according to any one of embodiments 1 through 12 wherein the PVP-containing polymer composition or the PVL-containing polymer composition is formed prior to contact with the porous substrate.

Embodiment 14 is the composite membrane according to any one of embodiments 1 through 13 wherein the PVP-containing polymer composition comprises a PVP homopolymer or copolymer (in certain embodiments, a PVP copolymer).

Embodiment 15 is the composite membrane according to embodiment 14 wherein the PVP-containing copolymer is a PVP-grafted PVA copolymer.

Embodiment 16 is the composite membrane according to any one of embodiments 1 through 13 wherein the PVL-containing polymer composition comprises a PVL homopolymer or copolymer (in certain embodiments, a PVL copolymer).

Embodiment 17 is the composite membrane according to embodiment 16 wherein the PVL-containing polymer composition comprises polyvinyl-β-propiolactam, polyvinyl-δ-valerolactam, polyvinyl-ε-caprolactam, or a combination thereof.

Embodiment 18 is the composite membrane according to any one of embodiments 1 through 17 wherein the porous substrate is a polymeric porous substrate.

Embodiment 19 is the composite membrane according to any one of embodiments 1 through 17 wherein the porous substrate is a ceramic porous substrate.

Embodiment 20 is the composite membrane according to any one of embodiments 1 through 19 wherein the porous substrate is asymmetric or symmetric.

Embodiment 21 is the composite membrane according to any one of embodiments 1 through 20 wherein the porous substrate comprises a nanoporous layer.

Embodiment 22 is the composite membrane according to embodiment 21 wherein the nanoporous layer is adjacent to or defines the first major surface of the porous substrate.

Embodiment 23 is the composite membrane according to any one of embodiments 1 through 22 wherein the porous substrate comprises a microporous layer.

Embodiment 24 is the composite membrane according to embodiment 23 wherein the microporous layer is adjacent to or defines the second major surface of the porous substrate.

Embodiment 25 is the composite membrane according to any one of embodiments 1 through 24 wherein the porous substrate comprises a macroporous layer.

Embodiment 26 is the composite membrane according to embodiment 25 wherein the macroporous layer is adjacent to or defines the second major surface of the porous substrate.

Embodiment 27 is the composite membrane according to any one of embodiments 1 through 26 wherein the porous substrate has a thickness measured from one to the other of the opposite major surfaces in the range of from 5 μm up to and including 500 μm.

Embodiment 28 is the composite membrane according to embodiment 21 or 22 wherein the nanoporous layer has a thickness in the range of from 0.01 μm up to and including 10 μm.

Embodiment 29 is the composite membrane according to embodiment 23 or 24 wherein the microporous layer has a thickness in the range of from 5 μm up to and including 300 μm.

Embodiment 30 is the composite membrane according to embodiment 25 or 26 wherein the macroporous layer has a thickness in the range of from 25 μm up to and including 500 μm.

Embodiment 31 is the composite membrane according to any one of embodiments 1 through 30 wherein the porous substrate comprises pores having an average size in the range of from 0.5 nanometer (nm) up to and including 1000 μm.

Embodiment 32 is the composite membrane according to any one of embodiments 21, 22, and 28 wherein the nanoporous layer comprises pores having a size in the range of from 0.5 nanometer (nm) up to and including 100 nm.

Embodiment 33 is the composite membrane according to any one of embodiments 23, 24, and 29 wherein the microporous layer comprises pores having a size in the range of from 0.01 μm up to and including 20 μm.

Embodiment 34 is the composite membrane according to any one of embodiments 25, 26, and 30 wherein the macroporous layer comprises pores having a size in the range of from 1 μm up to and including 1000 μm.

Embodiment 35 is the composite membrane according to any one of embodiments 1 through 34 wherein at least one polymer in the polymer composition is crosslinked and/or grafted to a nanoporous substrate.

Embodiment 36 is the composite membrane according to any one of embodiments 1 through 35 wherein the polymer composition comprises an interpenetrating network of two or more polymers.

Embodiment 37 is the composite membrane according to any one of embodiments 1 through 36, wherein the PVP-containing or PVL-containing copolymers include poly(vinylpyrrolidone/alkyl vinylimidazolium), poly(vinylpyrrolidone/methyacrylamide/vinylimidazole/quaternized vinylimidazole), poly(vinylcaprolactam/vinylpyrrolidone/quaternized vinylimidzaole), poly(vinylcarprolactam/vinylpyrrolidone/dimethylaminopropyl methacrylamide), poly(vinylpyrrolidone/dimethylamino propylmethacrylamide/methyacryloylaminopropyl lauryl dimethyl ammonium chloride), poly(vinylpyrrolidone/dimethylaminopropylmethacrylamide), poly(vinylpyrrolidone/methacrylamidopropyltrimethylammonium chloride), poly(vinylpyrrolidone/acrylic acid), poly(vinylpyrrolidone/vinyl acetate), graft copolymers of vinyl pyrrolidone, poly(vinylpyrrolidone/vinylamine), and combinations thereof.

Embodiment 38 is the composite membrane according to embodiment 36, the PVP-containing or PVL-containing copolymers include poly(vinylpyrrolidone/alkyl vinylimidazolium), poly(vinylpyrrolidone/methyacrylamide/vinylimidazole/quaternized vinylimidazole), poly(vinylcaprolactam/vinylpyrrolidone/quaternized vinylimidzaole), and combinations thereof.

Embodiment 39 is the composite membrane according to any one of embodiments 1 through 38 wherein the PVP-containing polymer composition (c) comprises one or more additional polymers that does not include a polymer derived from one or more (meth)acrylate-containing monomers and/or oligomers.

Embodiment 40 is the composite membrane according to any one of embodiments 1 through 39 wherein the polymer composition swells in the presence of alcohol and/or other high octane compound but not gasoline or other such fuel.

Embodiment 41 is the composite membrane according to any one of embodiments 1 through 40 wherein the polymer layer has a thickness in the range of from 10 nm up to and including 20,000 nm.

Embodiment 42 is the composite membrane according to any one of embodiments 1 through 41 wherein the polymer composition exhibits a high octane compound (e.g., an alcohol) selectivity in the range of from at least 30% up to and including 100%.

Embodiment 43 is the composite membrane according to any one of embodiments 1 through 42 wherein the polymer composition exhibits an average alcohol permeate (e.g., alcohol from an alcohol/gasoline mixture) flux in the range of from at least 300 g/m²/hour up to and including 30 kg/m²/hour, using a feed temperature in the range of from at least 20° C. up to and including 120° C., a permeate vacuum pressure in the range of from 20 Torr (2.67 kPa) to and including 760 Torr (101 kPa), a feed pressure in the range of at least 69 kPa up to and including 2.76 MPa, and an alcohol concentration in feed gasoline/alcohol mixture in the range of from at least 2% up to and including 20%.

Embodiment 44 is a composite membrane according to any one of embodiments 1 through 43 wherein the polymer composition comprises one or more additives selected from a polymeric additive, particulate, and a photoinitiator.

Embodiment 45 is a composite membrane according to any one of embodiments 1 through 44 further comprising at least one of:

(a) an ionic liquid mixed with the polymer composition; or

(b) an amorphous fluorochemical film disposed on the composite membrane.

Embodiment 46 is the composite membrane according to embodiment 45 wherein the amorphous fluorochemical film is a plasma-deposited fluorochemical film.

Embodiment 47 is the composite membrane according to embodiment 45 wherein the amorphous fluorochemical film comprises an amorphous glassy perfluoropolymer having a Tg at of least 100° C.

Embodiment 48 is a cartridge for separating alcohol from an alcohol and gasoline mixture, the cartridge comprising a composite membrane according to any one of embodiments 1 through 47.

Embodiment 49 is the cartridge according to embodiment 48 having a volume in the range of from 200 milliliters (mL), or from 500 mL, up to and including 5.000 liters (L).

Embodiment 50 is a fuel separation system comprising one or more cartridges, which may be in series or parallel, according to embodiment 48 or 49.

Embodiment 51 is a method of separating a first fluid (e.g., first liquid) from a mixture of the first fluid (e.g., first liquid) and a second fluid (e.g., second liquid), the method comprising contacting the mixture with a composite membrane according to any one of embodiments 1 through 47.

Embodiment 52 is the method according to embodiment 51 wherein the first fluid (e.g., first liquid) is an alcohol and/or a high octane compound and the second fluid (e.g., second liquid) is gasoline.

Embodiment 53 is the method according to embodiment 52 which is carried out under the following conditions: a feed temperature in the range of from at least 20° C. up to and including 120° C., a permeate vacuum pressure in the range of from 20 Torr (2.67 kPa) to and including 760 Torr (101 kPa), a feed pressure in the range of at least 69 kPa up to and including 2.76 MPa, and an alcohol concentration in feed gasoline/alcohol mixture in the range of from at least 2% up to and including 20%.

### EXAMPLES

Objects and advantages of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Materials

SR259, PEG200 diacrylate, from Sartomer Company, Exton, Pa.
PAN350, polyacrylonitrile substrate, Nanostone Water, formerly known as Sepro Membranes Inc., used as received
PHOTO1173, 2-hydroxy-2-methylpropiophenone, TCI-EP, Tokyo Kogyo Co. Ltd, Tokyo, Japan
MPrOH, 1-methoxy-2-propanol, Alfa Aesar, Ward Hill, Mass.
SR344, PEG400 diacrylate, Sartomer Company, Exton, Pa.
SR399, dipentaerythritol pentaacrylate, Sartomer Company, Exton, Pa.
K-90, polyvinylpyrrolidone, PVP, MW 360K, Spectrum Chemical MFG. Corp, Gardena, Calif.
K-12, polyvinylpyrrolidone, PVP, MW3500, Spectrum Chemical MFG. Corp, Gardena, Calif.
HEA, N-Hydroxyethyl acrylamide, Sigma Aldrich, Milwaukee, Wis.
V7154, PITZCOL 7154, polyvinylpyrrolidone (PVP) grafted polyvinyl alcohol (PVA), PVP-g-PVA, (PVP/PVA=50/50), obtained from Daiichi Kogyo Seiyaku, Japan
K90, PITZCOL K-90, polyvinylpyrrolidone (PVP), Daiichi Kogyo Seiyaku, Japan
TC-310, ORGATIX TC-310, Titanium lactate, Ti(OH)₂[OCH(CH₃)COOH]₂, obtained from Matsumoto Fine Chemical Co. Ltd., Japan
PVA, polyvinylalcohol, MW66K, Wako Pure Chemical, Japan

### V0078, PITZCOL 0078, PVP-g-PVA (PVP/PVA=80/20), Daiichi Kogyo Seiyaku, Japan

### Toluene, UN1294, BDH, VWR International LLC, Radnor, Pa.

o-Xylene, Alfa Aesar, Ward Hill, Mass.

### 1,2,4-Trimethylbenzene, Alfa Aesar, Ward Hill, Mass.

### Heptane, UN1206, BDH, VWR International LLC, Radnor, Pa.

### LUVIQUAT ULTRACARE, LUVIQUAT ULTRACARE AT 1, BASF Company, Florham Park, N.J.

### LUVIQUAT SUPREME AT, BASF Company, Florham Park, N.J.

### LUVIQUAT HOLD, BASF Company, Florham Park, N.J.

### LUVIQUAT HM552, BASF Company, Florham Park, N.J.

### P36, EBECRYL P36, Cytec Surface Specialties Inc., Smyrna, Ga.

H₂O₂, Sigma Aldrich, Milwaukee, Wis.

### Test Procedures

### Method 1

The ability of the membranes to separate ethanol from an ethanol/gasoline mixture was determined using the test apparatus depicted in FIG. 4 and the following technique. The membrane sample was mounted onto a stainless steel cell (SEPA CF II, obtained from General Electric Co., Fairfield, Conn.). The effective membrane surface area was 140 cm². A feedstock of E10 gasoline (containing about 10% ethanol) was heated by a heat exchanger and pumped through the membrane cell at a flow rate of 500 ml/min. The input and output temperatures of the feedstock at the inlet and outlet of the membrane cell were measured with thermocouples. The permeate was collected in a cold trap cooled with liquid nitrogen. The membrane cell vacuum was controlled by a regulator connected to a vacuum pump. Testing was performed under the following conditions: 70° C. feedstock temperature and 200 Torr (26.7 kPa) vacuum. The total permeate mass flux was calculated as:

$$Flux = \frac{m}{A \times t}$$

where m is the mass of the permeate in kilograms (kg); A is the effective membrane area in square meters (m²); and t is the permeate collection duration time in hours (h). The ethanol content of the permeate and the feedstock were measured by gas chromatography (GC) using an Agilent Model 7890C gas chromatograph. The alcohol content was determined by using a calibration line, obtained by running known concentrations of ethanol through the GC and measuring the GC response area. Then the response area measurements of the permeate and feedstock from the GC were obtained and then using the calibration line and the % ethanol was determined. Ethanol mass flux was calculated as membrane mass flux multiplied by the ethanol concentration in the permeate.

The each permeate collection lasted 10 min and five measurements were taken for each membrane. The average data of the last three measurements were used to represent the membrane performance.

### Method 2

The ability of the membranes to separate ethanol from an ethanol/gasoline mixture was determined as Method 1 above except the test apparatus was run in a continuous mode after charging the initial test vessel with about 1.1 liters of gasoline. Testing was conducted for 120 min. The flow rate of the feed stream was maintained at 500 mL/min. Vacuum in the membrane permeate side was set at 200 Torr (26.7 kPa) and the average gasoline temperature at the inlet and outlet of the membrane cell was maintained at 70° C. Permeate samples were collected every 5-10 minutes and the feed ethanol contents were monitored every 10 min. The time to reach 2% EtOH content was obtained by extending the trend line of the ethanol depletion curve. The average ethanol flux was calculated as follows

flux=m(c₀−2%)/t/A

Where m is the initial charged mass of feed gasoline, co is the initial ethanol concentration; t is the time for feed ethanol reaching 2%, and A is the active membrane area of the testing cell. The average permeate ethanol was calculated from all of the permeate collected.

### Method 3

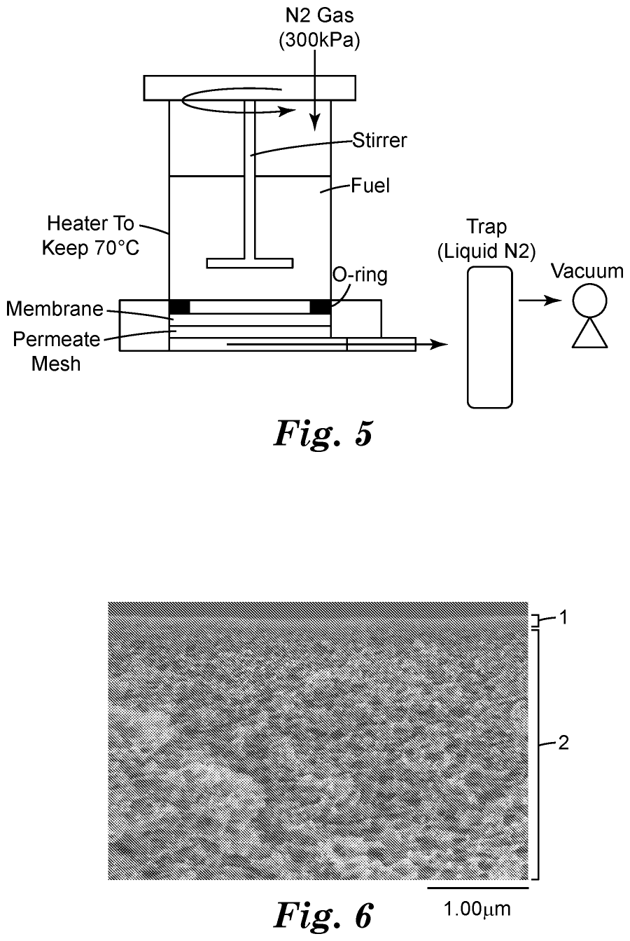

One 76-mm disk of a membrane sample was cut and mounted with a mesh support in a solvent resistant stirred cell (obtained from EMD-Millipore) as shown in FIG. 5. About 100 grams E10 gasoline were charged into the cell. The E10 gasoline (referred to as the feed) was heated up to 70° C. by one infrared lamp. The cell was pressured to 300 kPa by nitrogen to prevent the E10 gasoline from boiling, and 216 Torr (28.7 kPa) vacuum was applied to the permeate side by a diaphragm vacuum pump. The permeate vapor was condensed using a liquid nitrogen trap. Each sample was tested for 45 minutes. Membrane ethanol selectivity was determined by ethanol content in the permeate while the ethanol flux was determined by the end ethanol concentration in the feed gasoline. In other means, a lower end ethanol content implied a higher ethanol flux for a fixed run time of 45 minutes and starting E10 gasoline weight of 100 grams.

### Method 4

The membrane sample was soaked into a chamber of an autoclave with the temperature setting of 80° C. After a certain period of exposure time, the pressure was released and the sample was removed and dried out at ambient conditions. The performance of the hot gasoline exposed membrane was evaluated as in Method 1.

### Method 5

The ability of the membranes to separate both aromatics and ethanol was determined as Method 1 except that one model fuel was used for measurement. The model fuel was formulated by mixing 60 vol % heptane, 10 vol % toluene, 10 vol % o-xylene, 10 vol % 1,2,4-trimethylbenzene and 10 vol % ethanol. The content of each component in the permeate was analyzed by GC. The total aromatic selectivity was calculated by the total aromatic content (Toluene (T), o-xylene (X) and 1,2,4-trimethylbenzene (mB)) in the permeate excluding ethanol.

$$Aromatic selectivity = \frac{{c}_{T} + {c}_{X} + {c}_{m B}}{100 \% - {c}_{EtOH}}$$

Where c_{T} is toluene content in the permeate, cx is o-xylene content in the permeate, c_{mB} is 1,2,4-trimethylbenzene content in the permeate, and cam′ is ethanol content in the permeate.

### Coating 1

A coating solution was applied onto 203 mm×254 mm PAN350 at the nanoporous side using a Mayer rod #7. The coated sample was allowed to dry for about 2 min before UV curing (600 Watts Fusion UV-H bulb with aluminum reflector, line speed at 12.2 m/min).

### Coating 2

A slot die was used to apply a coating solution at a predetermined flow rate onto a moving porous substrate (PAN350). The coated substrate went through two ovens (3.05 meters long each oven) before UV curing (Fusion UV-H bulb, 300 Watts, with aluminum reflector). The substrate line speed was set to 3.05 m/min, the coating width was 203 mm, and the oven temperature set to 200° F. (93° C.).

### EXAMPLES

Examples 1-3 illustrate membranes prepared from solutions without any polymer additive

### Example 1 (Comparative)

A coating solution was mixed containing 10.0 wt-% SR259 and 2.0 wt-% photoinitiator, PHOTO1173 in the solvent MPrOH. With the solution above, a membrane was produced by Coating 1. The membrane showed excessive total flux with no ethanol selectivity.

### Example 2 (Comparative)

A membrane was prepared as in Example 1 except that a coating solution containing 10.0 wt-% SR344 and 2.0 wt-% PHOTO1173 in MPrOH was used. Again, the membrane showed excessive total flux and no ethanol selectivity.

### Example 3 (Comparative)

A membrane was prepared as in Example 1 except that a coating solution containing 10.0 wt-% SR399 and 2.0 wt-% PHOTO1173 in MPrOH by coating 1 was used. The membranes did not show the same excessive total flux as membranes in Examples 1-2, but showed extremely low ethanol selectivity.

### Examples 4-14 Illustrate Membranes Prepared from a Solution Containing a Polymer Additive

### Example 4

A membrane was prepared as in Example 1 except that a coating solution containing 9.0 wt-% SR259, 1.0 wt-% K-90, and 2.0 wt-% PHOTO1173 in MPrOH was used. The testing results are reported in Table 1 below. The target thickness was calculated from the solid content in the coating solution and the wet thickness a Mayer rod delivered. This membrane showed excellent ethanol flux and selectivity. Membrane durability performance was tested according to Method 4 and the results are reported in Table 5 below. After 140 hours exposure to hot gasoline, the performance change was not significant.

### Example 5

A coating solution was prepared as described in Example 4 and used to produce a membrane by roll-to-roll processing (Coating 2). Target coating thickness of the composite membrane was 1.0 μm and its testing results are reported in Table 1 below.

### Example 6

A membrane was prepared as in Example 5 except that its target coating thickness was 3.0 μm and the testing results are reported in Table 1 below. The membrane was tested by method 2 and the results are reported in Table 2 below.

### Example 7

A membrane was prepared as in Example 4 except that 2.0 wt-% PVP with molecular weight 1.3 MM (obtained from Sigma Aldrich, Milwaukee, Wis.) was used and the testing results are reported in Table 1 below. Increasing the PVP content increased the ethanol selectivity but decreased ethanol flux.

### Example 8

A membrane was prepared as in Example 4 except that 2.0 wt-% K-12 was used and the testing results are reported in Table 1 below. The membrane showed excessive permeate flux and no ethanol selectivity. One possibility is that a very low molecular weight PVP tended to intrude into the pores of PAN350 support. As a result, a continuous coating layer was not formed and the membrane may remain porous after coating.

### Examples 9-11 Illustrate the Effect of a Photoinitiator or Solvent Residue on Membrane Performance

### Example 9

A membrane was prepared as in Example 4 except a solution containing 2.0 wt-% K-90, 8.0% wt-% SR259 and 2.0 wt-% PHOTO1173 in MPrOH was coated and the testing results are reported in Table 1 below.

### Example 10

A membrane was prepared as in Example 9 except no photoinitiator was added in the coating solution and the testing results are reported in Table 1 below.

### Example 11

A membrane was prepared as in Example 9 by coating 1 except that the membrane drying time was extended to 30 min at ambient conditions to further reduce the solvent residue before UV curing. The test results are reported in Table 1 below.

### Examples 12-14 Illustrate the Effect of Acrylamide Co-Monomer on Membrane Performance

### Example 12

A membrane was prepared as in Example 4 except that a solution containing 1.0 wt-% K-90, 9.0 wt-% SR259 and 1.2 wt-% HEA, 2.0 wt-% PHOTO1173 in MPrOH was used and the test results are reported in Table 1 below.

### Example 13

A membrane was prepared as in Example 12 except that 2.6 wt-% HEA was added in the coating solution and the test results are reported in Table 1 below.

### Example 14

A membrane was prepared as in Example 12 except that 6.0 wt-% HEA was added in the coating solution and the test results are reported in Table 1 below.

The addition of acrylamide co-monomer showed an increase in ethanol selectivity, but ethanol flux was compromised to some extent.

### Examples 15-17 Illustrate Membranes Prepared from Only PVP Polymers

### Example 15

A membrane was prepared as in Example 4 except that a solution containing 2.0 wt-% K-90 and 2.0 wt-% PHOTO1173 in MPrOH (without any other polymerizable monomer) was used with 0.32 μm coating target thickness and the test results are reported in Table 1 below. Membrane durability performance was also tested according to Method 4 and the results are reported in Table 5 below. After 140 hours exposure to hot gasoline, performance change was not significant.

### Example 16

A membrane was prepared as in Example 15 except that a roll-to-roll processing (Coating 2) was used with 0.2 μm coating target thickness and the test results are reported in Table 1 below.

### Example 17

A membrane was prepared as in Example 15 except that there was no UV irradiation after coating and oven drying and the test results are reported in Table 1 below. Surprisingly even with no UV irradiation, the PVP composite membrane showed moderate ethanol selectivity and an excellent ethanol flux.

### Examples 18-23 Illustrate Effect of UV Dosage on Membrane Performance

### Example 18-20

Three samples from the membrane prepared in Example 17 was irradiated with 600 watts Fusion UV (H-bulb with aluminum reflector) at the line speed of 12.2 m/min for one pass (Example 18), two passes (Example 19) and three passes (Example 20), respectively. The test results are reported in Table 1 below. With the increasing UV dosage, ethanol selectivity increases while ethanol flux decreases.

### Examples 21-23

A membrane was prepared as in Example 17 except that the coating thickness was targeted at 1.0 μm. three samples from this membrane were UV irradiated as in Example 18-20 for one pass (Example 21), two passes (Example 22) and three passes (Example 23), respectively. The test results by Method 1 are reported in Table 1 below. Increasing the PVP thickness increased ethanol selectivity and had minimal effect on ethanol flux.

### Examples 24-28 Illustrate Effect of EB Irradiation on Membrane Performance

### Examples 24-28

Samples from the membrane prepared in Example 17 were irradiated with electron beam (EB) at various doses and power levels as shown in Table 3. Under very high EB dose and power, a membrane could completely lose separation function (e.g., Example 25), which indicates the PVP composition may damage under irradiation. For low to moderate EB dose, there is a general trend; EB irradiation decreased significantly ethanol flux of a membrane while ethanol selectivity increased slightly.

TABLE 1

| | Target dry | Total | | | EtOH |
|---|---|---|---|---|---|
| | coating | permeate | | | flux |
| | thickness | flux | Feed | Permeate | (kg/ |
| Example | (μm) | (kg/m² · h) | EtOH | EtOH | m² · h) |
| 1 | 1.6 | >100 | — | 10.4% | — |
| 2 | 1.6 | >100 | — | 11.7% | — |
| 3 | 1.6 | 6.43 | 10.8% | 13.3% | 0.85 |
| 4 | 1.6 | 6.43 | 9.0% | 73.6% | 4.73 |
| 5 | 1.0 | 6.86 | 10.0% | 67.75% | 4.66 |
| 6 | 3.0 | 8.57 | 9.6% | 66.3% | 5.68 |
| 7 | 1.6 | 3.71 | 8.1% | 77.8% | 2.88 |
| 8 | 1.6 | >100 | — | — | — |
| 9 | 1.6 | 10.29 | 8.9% | 59.9% | 6.16 |
| 10 | 1.6 | 13.57 | 7.8% | 50.4% | 6.83 |
| 11 | 1.6 | 14.43 | 8.6% | 46.3% | 6.67 |
| 12 | 1.8 | 2.57 | 9.3% | 94.8% | 2.44 |
| 13 | 2.1 | 2.57 | 9.2% | 100.2% | 2.58 |
| 14 | 2.6 | 1.39 | 10.1% | 97.7% | 1.36 |
| 15 | 0.32 | 9.14 | 8.0% | 60.6% | 5.54 |
| 16 | 0.2 | 8.43 | 8.3% | 60.9% | 5.12 |
| 17 | 0.2 | 14.43 | 8.7% | 48.8% | 7.03 |
| 18 | 0.2 | 10.00 | — | 54.77% | 5.47 |
| 19 | 0.2 | 4.86 | — | 76.72% | 3.70 |
| 20 | 0.2 | 6.00 | — | 73.73% | 4.40 |
| 21 | 1.0 | 8.00 | 8.3% | 59.38% | 4.74 |
| 22 | 1.0 | 7.00 | — | 68.37% | 4.78 |
| 23 | 1.0 | 7.14 | — | 66.97% | 4.78 |

TABLE 2

| | Average | |
|---|---|---|
| | Permeate | Average EtOH |
| Example | EtOH | flux (kg/m² · h) |
| 5 | 62.5% | 2.32 |

TABLE 3

| | | | Total | | | |
|---|---|---|---|---|---|---|
| | | EB power | permeate | | | |
| | EB Dose | level | flux | Feed | Permeate | EtOH flux |
| Example | (Mrad) | (keV) | (kg/m² · h) | EtOH | EtOH | (kg/m² · h) |
| 17 | — | — | 14.43 | 8.7% | 48.8% | 7.03 |
| 24 | 5 | 300 | 10.14 | 8.5% | 51.50% | 5.22 |
| 25 | 10 | 300 | >100 | — | — | — |
| 26 | 5 | 200 | 9.00 | 8.0% | 53.50% | 4.81 |
| 27 | 10 | 200 | 12.14 | — | 46.49% | 5.62 |
| 28 | 10 | 110 | 9.71 | 8.4% | 53.87% | 5.23 |

### Examples 29-44 Illustrate Membranes Prepared from PVP Copolymer or PVP Polymer Blends

### Example 29

A membrane was prepared by coating a 5.0 wt-% PVP-grafted PVA, V7154 in water onto a PAN350 sample using a Mayer Rod with the target thickness at 0.2 μm. The coated composite membrane was dried in a convection oven at 80° C. for 1 min before performance evaluation by Method 3. The test results are reported in Table 4 below. The membrane ethanol selectivity went up to 72.7%, but after 45 min separation, ethanol content in the feed remained as high as 6.1%. This means the ethanol flux was low.

### Example 30

A membrane was prepared as in Example 29 except that 70 mass parts of V7154 and 30 mass parts of K90 (PITZCOL K-90) were used to formulate a 5.0 wt-% coating solution and the target coating thickness was 0.1 μm. The test results are reported in Table 4 below. After adding more PVP components, ethanol flux significantly increased with a much lower end ethanol feed content.

### Example 31

A membrane was prepared as in Example 30 except that the target coating thickness was 1.0 μm. The testing results are reported in Table 4 below. Membrane performance appears insensitive to the coating thickness from 0.1 to 1.0 μm.

### Example 32

A membrane was prepared as in Example 30 except that the target coating thickness was 0.3 μm. The test results are reported in Table 4 below.

### Example 33

A membrane was prepared as in Example 32 except an additional 5.15 mass part of TC-310 was added in the coating solution. The coated membrane was baked in a convection oven (80° C.) for one hour before performance evaluation. Compared to Example 32, addition of TC-310 increased ethanol selectivity but reduced ethanol flux.

### Example 34

A membrane was prepared as in Example 29 except that 60 mass parts of V7154 and 40 mass parts of K90 were used to formulate a 5.0 wt-% coating solution and the target coating thickness was 0.3 μm. The test results are reported in Table 4 below.

### Example 35

A membrane was prepared as in Example 34 except an additional 4.43 mass part of TC-310 was added in the coating solution. The coated membrane was baked in a convection oven (80° C.) for one hour before performance evaluation. The testing results are reported in Table 4 below.

### Example 36

55 mass parts of V7154 and 45 mass parts of K90 were mixed to formulate a 5.0 wt-% coating solution and an additional 4.06 mass parts of TC-310 was added into the coating solution. The solution above was coated onto a PAN350 using a Mayer Rod to target a dry coating thickness of 0.3 μm. The coated membrane was dried and baked in a convection oven (80° C.) for one hour before performance evaluation. The test results are reported in Table 4 below.

### Example 37

A membrane was prepared as in Example 36 except that the coated membrane was irradiated by UV (600 watts Fusion system with H bulb and an aluminum reflector, the line speed at 14.4 m/min) for four passes. The UV irradiated membrane was baked in a convection oven (80° C.) for one hour before performance evaluation. The test results are reported in Table 4 below. Compared to the membrane in Example 36, UV irradiation increased ethanol selectivity.

### Example 38

A membrane was prepared as in Example 36 except that 70 mass parts of K90 and 30 mass parts of PVA were used to formulate a 5.0 wt-% coating solution and an additional 4.43 mass parts of TC-310 was added into the coating solution. The coated membrane was baked in a convection oven (80° C.) for one hour before performance evaluation. The test results are reported in Table 4 below.

### Example 39

A membrane was prepared as in Example 38 except that the coated membrane was irradiated by UV (600 watts Fusion system with H bulb and an aluminum reflector, and the line speed at 14.4 m/min) for four passes. The UV irradiated membrane was baked in a convection oven (80° C.) for one hour before performance evaluation. The test results are reported in Table 4 below.

### Example 40

A membrane was prepared as in Example 36 except that 91 mass parts of V0078 and 9 mass parts of PVA were used to formulate a 5.0 wt-% coating solution and an additional 4.02 mass parts of TC-310 was added into the coating solution. The coated membrane was baked in a convection oven (80° C.) for one hour before performance evaluation. The test results are reported in Table 4 below.

### Example 41

A membrane was prepared as in Example 40 except that the coated membrane was irradiated by UV (600 watts Fusion system with H bulb, an alumina reflector, and the line speed at 14.4 m/min) for four passes. The UV irradiated membrane was baked in a convection oven for one hour (80° C.) before performance evaluation. The test results are reported in Table 4 below.

### Example 42

A membrane was prepared as in Example 29 except that 60 mass parts of V7154 and 40 mass parts of K90 were used to formulate a 5.0 wt-% coating solution and the target coating thickness was 0.3 μm. the coated membrane was irradiated by UV (600 watts Fusion system with H bulb, an alumina reflector, and the line speed at 14.4 m/min) for four passes. The test results are reported in Table 4 below.

### Example 43

A membrane was prepared as in Example 42 except that an additional 4.38 mass parts of TC-310 was added in the coating solution. The test results are reported in Table 4 below.

### Example 44

100 mass parts of V0078 were mixed to formulate a 5.0 wt-% coating solution in water and an additional 2.99 mass parts of TC-310 was added into the coating solution. The solution above was coated onto a PAN350 using a Mayer Rod to target at dry coating thickness of 0.3 μm. The coated membrane was irradiated by UV (600 watts Fusion system with H bulb, an alumina reflector, and the line speed at 14.4 m/min) for four passes. The UV irradiated membrane was baked in a convection oven (80° C.) for one hour before performance. The testing results are reported in Table 4 below.

TABLE 4

| | TC-310 | PVP component | UV | Target coating | | Permeate |
|---|---|---|---|---|---|---|
| Example | wt-% | percentage (%) | irradiation | Thickness (μm) | End EtOH (%) | EtOH (%) |
| 29 | 0 | 50.0 | No | 0.2 | 6.1 | 72.7 |
| 30 | 0 | 65.0 | No | 0.1 | 2.6 | 55.2 |
| 31 | 0 | 65.0 | No | 1.0 | 2.8 | 57.7 |
| 32 | 0 | 65.0 | No | 0.3 | 2.4 | 58.9 |
| 33 | 4.9 | 61.8 | No | 0.3 | 4.1 | 70.2 |
| 34 | 0 | 70.0 | No | 0.3 | 2.4 | 58.9 |
| 35 | 4.2 | 67.0 | No | 0.3 | 3.1 | 61.5 |
| 36 | 3.9 | 69.7 | No | 0.3 | 2.3 | 54.5 |
| 37 | 3.9 | 69.7 | Yes | 0.3 | 3.0 | 63.4 |
| 38 | 4.2 | 67.0 | No | 0.3 | 2.4 | 54.7 |
| 39 | 4.2 | 67.0 | Yes | 0.3 | 2.6 | 60.9 |
| 40 | 3.9 | 70.0 | No | 0.3 | 2.3 | 56.8 |
| 41 | 3.9 | 70.0 | Yes | 0.3 | 2.5 | 59.5 |
| 42 | 0 | 70.0 | Yes | 0.3 | 2.3 | 58.1 |
| 43 | 4.2 | 67.0 | Yes | 0.3 | 2.8 | 63.3 |
| 44 | 2.9 | 77.7 | Yes | 0.3 | 1.4 | 32.5 |

TABLE 5

| | | | Total | | | |
|---|---|---|---|---|---|---|
| | Soaking | Soaking | permeate | | | |
| | temperature | duration | flux | Feed | Permeate | EtOH flux |
| Example | (° C.) | (hours) | (kg/m² · h) | EtOH | EtOH % | (kg/m² · h) |
| 4 | — | — | 6.43 | 9.03% | 73.64% | 4.73 |
| | 70 | 100 | 5.29 | 8.01% | 79.48% | 4.21 |
| | 80 | 140 | 5.00 | 8.33% | 71.69% | 3.59 |
| | 80 | 140 | 6.71 | 7.16% | 71.49% | 4.80 |
| 15 | — | — | 9.14 | 7.99% | 60.61% | 5.54 |
| | 80 | 140 | 8.00 | 8.10% | 64.42% | 5.15 |

### Example 45

A coating solution was mixed containing 5.0 wt-% LUVIQUAT HM552 in deionized water. The coating solution was applied on top of a PAN350 substrate using a Mayer rod #7. The coated membrane was allowed to dry at ambient conditions for about 30 min followed by further drying in a vacuum-oven with temperature setting of 80° C. for about one hour. The dry membrane was tested using Method 1 above with the results reported in Table 6 below. HM552 is a copolymer of vinylpyrrolidone and quaternized vinylimidazole. In comparison with the membranes in Examples 15-17 produced with polyvinylpyrrolidone homopolymer, this copolymer membrane showed dramatically increased ethanol selectivity while ethanol flux remains outstanding. Also, this copolymer coated membrane appeared to be able to survive hot gasoline environment.

### Example 46

A coating solution was mixed containing 2.0 wt-% PHOTO1173 in MPrOH. This solution was coated on top of one membrane produced as Example 45. The photoinitator overcoated membrane went through a UV chamber equipped with 600 watts Fusion UV system with H bulb and an aluminum reflector. The curing line speed was set at 12.2 meter/min. the cured membrane was tested using Method 1 with the results reported in Table 6 below. UV irradiated membrane further increased ethanol selectivity.

### Example 47

A coating solution was mixed containing 5.0 wt-% LUVIQUAT HOLD in deionized water. The coating solution was applied on top of a PAN350 substrate using a Mayer rod #7. The coated membrane was allowed to dry at ambient conditions for about 30 min followed by further drying in a vacuum-oven with temperature setting of 80° C. for about one hour. The dry membrane was tested using Method 1 above with the results reported in Table 6 below.

### Example 48

A coating solution was mixed containing 2.0 wt-% PHOTO1173 in MPrOH. This solution was coated on top of one membrane produced as Example 47. The photoinitiator overcoated membrane went through a UV chamber equipped with 600 watts Fusion UV system with H bulb and an aluminum reflector. The curing line speed was set at 12.2 meter/min. The cured membrane was tested using Method 1 with the results reported in Table 6 below.

### Example 49

A coating solution was mixed containing 5.0 wt-% LUVIQUAT SUPREME AT in deionized water. The coating solution was applied on top of a PAN350 substrate using a Mayer rod #7. The coated membrane was allowed to dry at ambient conditions for about 30 min followed by further drying in a vacuum-oven with temperature setting of 80° C. for about one hour. The dry membrane was tested using Method 1 above with the results reported in Table 6 below.

### Example 50

A coating solution was mixed containing 1.0 wt-% PHOTO1173 in MPrOH. This solution was coated on top of one membrane produced as Example 49. The photoinitiator overcoated membrane went through a UV chamber equipped with 600 watts Fusion UV system with H bulb and an aluminum reflector. The curing line speed was set at 12.2 meter/min. The cured membrane was tested using Method 1 with the results reported in Table 6 below.

### Example 51

A coating solution was mixed containing 5.0 wt-% LUVIQUAT ULTRACARE AT in deionized water. The coating solution was applied on top of a PAN350 substrate using a Mayer rod #7. The coated membrane was allowed to dry at ambient conditions for about 30 min followed by further drying in a vacuum-oven with temperature setting of 80° C. for about one hour. The dry membrane was tested using Method 1 above with the results reported in Table 6 below.

### Example 52

A membrane was produced as Example 51 except that the coating solution contained 2.0 wt-% LUVIQUAT ULTRACARE AT in deionized water. The dry membrane was tested using Method 1 above with the results reported in Table 6 below.

### Example 53

A membrane was produced as Example 51 except that the coating solution contained 1.0 wt-% LUVIQUAT ULTRACARE AT in deionized water. The dry membrane was tested using Method 1 above with the results reported in Table 6 below.

### Example 54

An overcoating solution was mixed containing 0.3 wt-% H₂O₂ in deionized water. This overcoating solution was applied on top of one membrane produced as Example 52. The overcoated membrane went through a UV chamber equipped with 600 watts Fusion UV system with H bulb and an aluminum reflector. The curing line speed was set at 12.2 meter/min. The cured membrane was tested using Method 1 with the results reported in Table 6 below.

### Example 55

A membrane was produced as Example 54 except that the over-coating solution was mixed containing 1.0 wt-% PHOTO1173 in MPrOH. The cured membrane was tested using Method 1 with the results reported in Table 6 below.

### Example 56

A membrane was produced as Example 54 except that the over-coating solution was mixed containing 1.0 wt-% photo1173 and 9.0 wt-% SR259 in MPrOH. The cured membrane was tested using Method 1 with the results reported in Table 6 below.

### Example 57

A membrane was produced as Example 54 except that the over-coating solution was mixed containing 1.0 wt-% EBECRYL P36 in MPrOH. The cured membrane was tested using Method 1 with the results reported in Table 6 below.

### Example 58

A membrane was produced as Example 54 except that the over-coating solution was mixed containing 1.0 wt-% EBECRYL P36 and 9.0 wt-% SR259 in MPrOH. The cured membrane was tested using Method 1 with the results reported in Table 6 below.

### Example 59

A membrane was produced as Example 6 in a pilot line. The membrane was tested using Method 1 to evaluate ethanol separation and using Method 5 to evaluate separation performance of both ethanol and aromatics with a model fuel. The results are reported in Table 6 and 7, respectively. As can be seen, besides ethanol separation, the membrane showed strong aromatic enrichment effect in the permeate. Since both ethanol and aromatics have high octane number, with the high percentage of EtOH and aromatics, the permeate can be used as a high octane fuel.

### Example 60

A coating solution was mixed containing 1.0 wt-% LUVIQUAT ULTRACARE AT and 1.0 wt-% PHOTO1173 in MPrOH. The coating solution was applied on top of a PAN350 substrate in pilot line as described in Coating 2. The target drying thickness was targeted at 0.61 μm. The membrane was tested using Method 1 to evaluate ethanol separation and using Method 5 to evaluate separation performance of both ethanol and aromatics with a model fuel. The results are reported in Table 6 and 7, respectively. This membrane also shows enrichment of both ethanol and aromatics.

The permeate contains a very high percentage of high octane components.

### Example 61

A coating solution was mixed containing 2.0 wt-% LUVIQUAT ULTRACARE AT 1 and 0.5 wt-% BASF IRGACURE 2959 photo-initiator in MPrOH. This solution was applied to a 4.6-5.5 mil thick nylon substrate, made by 3M Company from Saint Paul, Minn., with a #20 Mayer rod and dried at 70° C. for 5 minutes. A second coating was applied to the first with the #20 Mayer rod and also dried at 70° C. for 5 minutes. The resultant coated membrane went through a UV chamber equipped with a 600 watt Fusion UV system having bulb H and an aluminum reflector. The cured membrane was tested using Method 1 above with the results reported in Table 6 below.

TABLE 6

| | Target dry | Total | | | |
|---|---|---|---|---|---|
| | coating | permeate | | | EtOH |
| | thickness | flux | Feed | Permeate | flux |
| Example | (μm) | (kg/m² · h) | EtOH | EtOH | (kg/m² · h) |
| 45 | 0.80 | 5.29 | — | 86.2% | 4.55 |
| 46 | 0.80 | 4.29 | 7.9% | 92.5% | 3.97 |
| 47 | 0.80 | 19.86 | 8.5% | 36.7% | 7.30 |
| 48 | 0.80 | 17.14 | 8.3% | 41.6% | 7.13 |
| 49 | 0.80 | 2.29 | 7.7% | 96.1% | 2.20 |
| 50 | 0.80 | 2.57 | 8.2% | 97.8% | 2.52 |
| 51 | 0.80 | 6.86 | 8.0% | 72.1% | 4.95 |
| 52 | 0.32 | 9.14 | 8.3% | 62.5% | 5.71 |
| 53 | 0.16 | 9.14 | 8.4% | 62.8% | 5.73 |
| 54 | 0.32 | 8.29 | 8.1% | 68.9% | 5.71 |
| 55 | 0.32 | 8.00 | 8.1% | 69.3% | 5.54 |
| 56 | 1.76 | 7.43 | 7.4% | 71.1% | 5.28 |
| 57 | 0.32 | 8.86 | 8.8% | 67.2% | 5.96 |
| 58 | 1.76 | 7.86 | 8.0% | 68.8% | 5.40 |
| 59 | 3.00 | 5.57 | 8.2% | 65.5% | 3.65 |
| 60 | 0.61 | 7.14 | 9.1% | 76.2% | 5.42 |
| 61 | 2.65 | 4.57 | 8.5% | 78.8% | 3.60 |

TABLE 7

| | Total Mass | | Permeate | Permeate | Total fluxes |
|---|---|---|---|---|---|
| | Flux | Permeate | aromatics | overall | (EtOH + |
| Example | (kg/ | EtOH | Excluding | (EtOH + | aromatics) |
| # | m²/h) | Conc. | EtOH | aromatics) | (kg/m²/h) |
| 59 | 4.86 | 69.4% | 50.3% | 84.8% | 4.12 |
| 60 | 6.71 | 71.5% | 52.3% | 86.2% | 5.77 |

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A composite membrane for selectively pervaporating a high octane compound from a feed mixture comprising the high octane compound and gasoline, the composite membrane comprising:
a porous substrate comprising opposite first and second major surfaces, and a plurality of pores; and
a polymer composition, wherein the polymer composition is:
(a) a PVP-containing polymer composition that is not a pore-filling polymer composition;
(b) a PVP-containing polymer composition comprising greater than 75 wt-% PVP, wherein the PVP-containing polymer composition is in and/or on the porous substrate;
(c) a PVP-containing polymer composition comprising one or more additional polymers that does not include a polymer derived from one or more ethylenically unsaturated monomers and/or oligomers, wherein the PVP-containing polymer composition is in and/or on the porous substrate; or
(d) a PVL-containing polymer composition disposed in and/or on the porous substrate;
wherein the polymer composition forms a polymer layer having a thickness;
wherein the polymer composition is more permeable to the high octane compound than gasoline; and
wherein the polymer composition comprises at least one polymer crosslinked with actinic radiation and/or at least one polymer grafted to the porous substrate.

2. The composite membrane according to claim 1, wherein the high octane compound is an alcohol.

3. The composite membrane according to claim 2 wherein the PVP-containing polymer composition or the PVL-containing polymer composition is formed prior to contact with the porous substrate.

4. The composite membrane according to claim 3 wherein the PVP-containing polymer composition comprises a PVP homopolymer or copolymer.

5. The composite membrane according to claim 4 wherein the PVP-containing polymer composition comprises a PVP copolymer.

6. The composite membrane according to claim 3 wherein the PVL-containing polymer composition comprises a PVL homopolymer or copolymer.

7. The composite membrane according to claim 6 wherein the porous substrate comprises a nanoporous layer, a microporous layer, and a macroporous layer, in that order.

8. The composite membrane according to claim 7 wherein the porous substrate has a thickness measured from one to the other of the opposite major surfaces in the range of from 5 μm up to and including 500 μm and wherein the porous substrate comprises pores having an average size in the range of from 0.5 nanometer (nm) up to and including 1000 μm.

9. The composite membrane according to claim 8, wherein the PVP-containing or PVL-containing copolymers include poly(vinylpyrrolidone/alkyl vinylimidazolium), poly(vinylpyrrolidone/methyacrylamide/vinylimidazole/quaternized vinylimidazole), poly(vinylcaprolactam/vinylpyrrolidone/quaternized vinylimidzaole), poly(vinylcarprolactam/vinylpyrrolidone/dimethylaminopropyl methacrylamide), poly(vinylpyrrolidone/dimethylamino propylmethacrylamide/methyacryloylaminopropyl lauryl dimethyl ammonium chloride), poly(vinylpyrrolidone/dimethylaminopropylmethacrylamide), poly(vinylpyrrolidone/methacrylamidopropyltrimethylammonium chloride), poly(vinylpyrrolidone/acrylic acid), poly(vinylpyrrolidone/vinyl acetate), graft copolymers of vinyl pyrrolidone, poly(vinylpyrrolidone/vinylamine), and combinations thereof.

10. The composite membrane according to claim 9 wherein the polymer composition is a pore-filling polymer composition in the form of a pore-filling polymer layer that forms at least a portion of the first major surface of the porous substrate.

11. The composite membrane according to claim 9
further comprising at least one of:
(a) an ionic liquid mixed with the polymer composition; or
(b) an amorphous fluorochemical film disposed on the composite membrane.

12. The composite membrane according to claim 11 wherein the amorphous fluorochemical film is a plasma-deposited fluorochemical film.

13. The composite membrane according to claim 11 wherein the amorphous fluorochemical film comprises an amorphous glassy perfluoropolymer having a Tg at of least 100° C.

14. A cartridge for separating alcohol and/or other high octane compound from a feed mixture comprising gasoline and the alcohol and/or other high octane compound, the cartridge comprising a composite membrane according to claim 1.

15. A method of separating alcohol and/or other high octane compound from a feed mixture comprising gasoline and the alcohol and/or other high octane compound, the method comprising contacting the mixture with a composite membrane according to claim 1.
